(19) United States
(12) Patent Application Publication
(10) Pub. No.: US 2024/0220604 A1
(43) Pub. Date: Jul. 4, 2024

(54) LOG PROCESSING DEVICE, LOG PROCESSING METHOD AND COMPUTER READABLE MEDIUM

(71) Applicant: Mitsubishi Electric Corporation, Tokyo (JP)

(72) Inventors: Takumi YAMAMOTO, Tokyo (JP); Kiyoto KAWAUCHI, Tokyo (JP); Keisuke KITO, Tokyo (JP)

(73) Assignee: Mitsubishi Electric Corporation, Tokyo (JP)

(21) Appl. No.: 18/423,974

(22) Filed: Jan. 26, 2024

Related U.S. Application Data
(63) Continuation of application No. PCT/JP2021/034631, filed on Sep. 21, 2021.

(51) Int. Cl. G06F 21/53

(52) U.S. Cl. CPC G06F 21/53; G06F 2221/034

(57) ABSTRACT

A customer environment log generation unit (130) acquires a simulated environment log (410) being a log that indicates a behavior estimated to occur in a simulated environment (200) when an attack is made on the simulated environment (200) being a system environment which simulates a customer environment (300) being an actual system environment and which has a difference from the customer environment (300). Further, the customer environment log generation unit (130) converts the simulated environment log (410) into a customer environment log (430) being a log that indicates a behavior estimated to occur in the customer environment (300) when an attack corresponding to the attack against the simulated environment (200) is made on the customer environment (300), by reflecting the difference between the simulated environment (200) and the customer environment (300).

### CROSS REFERENCE TO RELATED APPLICATIONS

This application is a Continuation of PCT International Application No. PCT/JP2021/034631, filed on Sep. 21, 2021, which is hereby expressly incorporated by reference into the present application.

### TECHNICAL FIELD

The present disclosure relates to a technique to acquire a log indicating a behavior occurred when there is a cyber attack.

### BACKGROUND ART

As a technique related to the present disclosure, there is a technique disclosed in Patent Literature 1.

In the technique of Patent Literature 1, logs of an attack command server in executing a virtual targeted attack along with a targeted attack scenario are collected.

### CITATION LIST

### Patent Literature

Patent Literature 1: WO2020/255359

### SUMMARY OF INVENTION

### Technical Problem

In the technique of Patent Literature 1, it is possible to acquire a log on an attacker side indicating behaviors of the attack command server in making an attack. Meanwhile, in order to construct an attack detection system capable of coping with a cyber attack effectively, it is also necessary to analyze a log on an attacked side indicating behaviors of an attacked system being under attack. However, the technique of Patent Literature 1 is not for acquiring the log on the attacked side.

In order to acquire the log on the attacked side, it may be considered to make an attack on a system environment (hereinafter referred to as “actual environment”) where a customer system, etc. exists. However, since there is a possibility that the attack has a negative impact on the actual environment, from a security perspective, it is difficult to actually make an attack on the actual environment. Therefore, there is a problem that it is not possible to acquire a log indicating behaviors in the actual environment when the actual environment is attacked, without adversely affecting the actual environment.

One of the major aims of the present disclosure is to solve the problem as described above. More specifically, the present disclosure is mainly aimed at acquiring a log indicating behaviors in the actual environment when the actual environment is attacked, without adversely affecting the actual environment.

### Solution to Problem

A log processing device according to the present disclosure, includes:
a log acquisition unit to acquire a simulated environment log being a log that indicates a behavior estimated to occur in a simulated environment when an attack is made on the simulated environment being a system environment which simulates an actual environment being an actual system environment and which has a difference from the actual environment, and
a log conversion unit to convert the simulated environment log into an actual environment log being a log that indicates a behavior estimated to occur in the actual environment when an attack corresponding to the attack against the simulated environment is made on the actual environment, by reflecting the difference between the simulated environment and the actual environment.

### Advantageous Effects of Invention

According to the present disclosure, it is possible to acquire a log indicating behaviors in the actual environment when the actual environment is attacked, without adversely affecting the existent environment.

### BRIEF DESCRIPTION OF DRAWINGS

FIG. 1 is a diagram illustrating an outline of an operation of a log processing device according to a first embodiment;

FIG. 2 is a diagram illustrating an outline of an operation of the log processing device according to the first embodiment;

FIG. 3 is a diagram illustrating an example of a functional configuration of the log processing device according to the first embodiment;

FIG. 4 is a diagram illustrating an example of a hardware configuration of the log processing device according to the first embodiment;

FIG. 5 is a diagram illustrating an example of an internal configuration of a simulated environment log generation unit according to the first embodiment;

FIG. 6 is a diagram illustrating an example of a simulated environment log according to the first embodiment;

FIG. 7 is a diagram illustrating an example of a step-log correspondence table according to the first embodiment;

FIG. 8 is a diagram illustrating an example of an internal configuration of a customer environment log generation unit according to the first embodiment;

FIG. 9 is a flowchart illustrating a detail of a simulated environment log generation process (Step S110) according to the first embodiment;

FIG. 10 is a flowchart illustrating a detail of Step S113 according to the first embodiment;

FIG. 11 is a flowchart illustrating a detail of Step S114 according to the first embodiment;

FIG. 12 is a flowchart illustrating a detail of a customer environment log generation process (Step S130) according to the first embodiment;

FIG. 13 is a flowchart illustrating a detail of Step S132 according to the first embodiment;

FIG. 14 is a diagram illustrating an example of a simulated environment attack scenario and a simulated environment log according to the first embodiment;

FIG. 15 is a diagram illustrating an example of the customer environment attack scenario, the simulated environment log and the customer environment log according to the first embodiment;

FIG. 16 is a diagram illustrating an example of the customer environment attack scenario, the simulated environment log and the customer environment log according to the first embodiment;

FIG. 17 is a diagram illustrating an example of a functional configuration of a log processing device according to a second embodiment;

FIG. 18 is a diagram illustrating an example of an internal configuration of a parameter decision unit according to the second embodiment;

FIG. 19 is a diagram illustrating an example of an internal configuration of a setting changing unit according to the second embodiment;

FIG. 20 is a diagram illustrating an example of an internal configuration of a simulated environment log generation unit according to the second embodiment;

FIG. 21 is a diagram illustrating an example of an internal configuration of the customer environment log generation unit according to the second embodiment;

FIG. 22 is a flowchart illustrating an operation example of the log processing device according to the second embodiment;

FIG. 23 is a diagram illustrating an example of a functional configuration of a log processing device according to a third embodiment;

FIG. 24 is a diagram illustrating an example of an internal configuration of a log integration unit according to the third embodiment;

FIG. 25 is a flowchart illustrating an operation example of the log processing device according to the third embodiment;

FIG. 26 is a flowchart illustrating a detail of Step S163 according to the third embodiment;

FIG. 27 is a diagram illustrating an example of destruction information according to the third embodiment;

FIG. 28 is a diagram illustrating an example of a log according to the second embodiment; and

FIG. 29 is a diagram illustrating an example of a functional configuration of a log processing device according to a fourth embodiment.

### DESCRIPTION OF EMBODIMENTS

Hereinafter, description will be made on embodiments with reference to diagrams. In the following description and diagrams of the embodiments, same elements or corresponding elements are denoted by same reference numerals.

### First Embodiment

### Outline

In a present embodiment, a log processing device 100 is described.

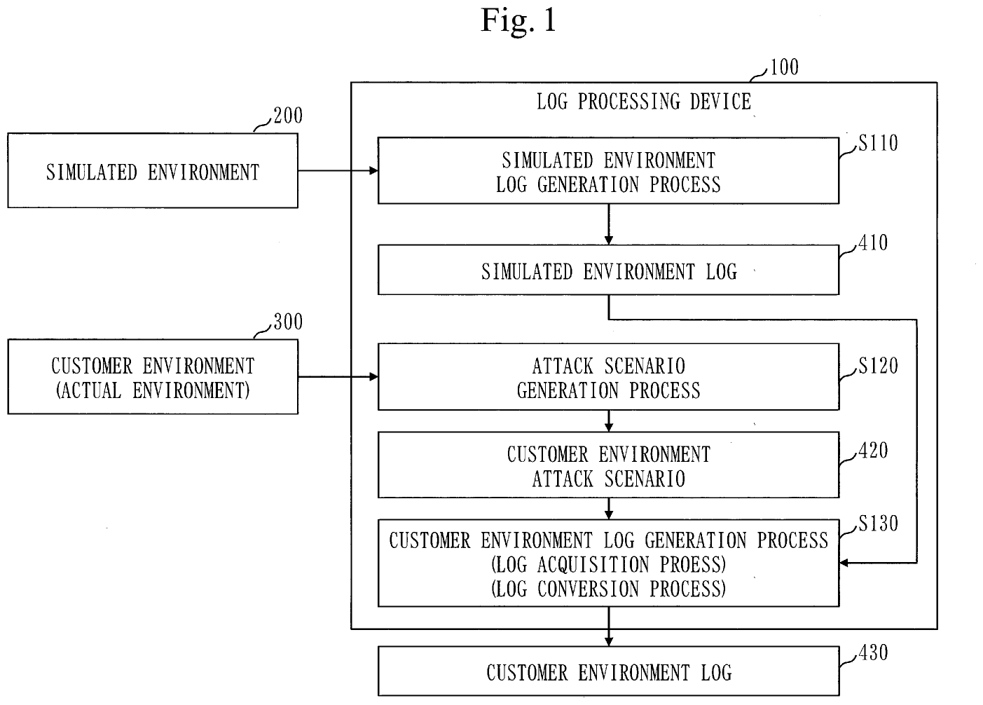

FIG. 1 illustrates an outline of an operation of the log processing device 100 according to the present embodiment.

First, with reference to FIG. 1, the outline of the operation of the log processing device 100 will be described.

The operation procedure of the log processing device 100 corresponds to a log processing method. Further, a program to realize the operation of the log processing device 100 corresponds to a log processing program.

The log processing device 100 converts a simulated environment log 410 and acquires a customer environment log 430.

The simulated environment log 410 is a log indicating a behavior estimated to occur in a simulated environment 200 when the simulated environment 200 is attacked.

The customer environment log 430 is a log indicating a behavior estimated to occur in a customer environment 300 when the customer environment 300 is attacked. The customer environment log 430 corresponds to an actual environment log.

The customer environment 300 is a system environment operating at a customer. The customer is a business entity such as a company, a public authority, a school, a research institute or the like. The customer environment 300 is a business system of the customer, for example. Since the customer environment 300 is a system environment that actually exists, the customer environment 300 corresponds to an example of the actual environment. In the customer environment 300, there exist a PC (Personal Computer), a proxy server device, an AD (Active Directory) server device, a file server device, and an internal network and the like, as system components. Furthermore, in the customer environment 300, there exist files, users and the like as system components.

The simulated environment 200 is a system environment to simulate the customer environment 300. In the simulated environment 200, there exist a PC, a proxy server device, an AD (Active Directory) server device, a file server device, an internal network or the like, as with the customer environment 300. Further, in the simulated environment 200, files, users and the like exist, as system components.

Although the simulated environment 200 simulates the customer environment 300, the simulated environment 200 has a difference in parameter values from the customer environment 300. The parameter values are setting values to make an information system function, such as communication addresses, setting information, identifiers of computers, identifiers of users, identifiers of files, passwords, and the like.

The parameter values used in the simulated environment 200 are called simulate environment parameter values, and the parameter values used in the customer environment 300 are called customer environment parameter values. The customer environment parameter values correspond to actual environment parameter values.

The log processing device 100 converts the simulated environment log 410 into the customer environment log 430 by reflecting difference between the simulated environment 200 and the customer environment 300. Specifically, the log processing device 100 converts the simulated environment log 410 into the customer environment log 430 by reflecting difference in the parameter values between the simulated environment 200 and the customer environment 300. Therefore, in the customer environment log 430, the difference in the parameter values between the simulated environment 200 and the customer environment 300 is absorbed.

Next, an operation procedure in the log processing device 100 will be described.

The log processing device 100 makes a virtual attack on the simulated environment 200, and generates a simulated environment log 410, in a simulated environment log generation process (Step S110).

Next, the log processing device 100 generates a customer environment attack scenario 420 indicating an attack procedure against the customer environment 300 in an attack scenario generation process (Step S120). The customer environment attack scenario 420 indicates an attack procedure of an attack similar to the attack on the simulated environment 200.

Next, in a customer environment log generation process (Step S130), the log processing device 100 reflects the difference between the simulated environment 200 and the customer environment 300, uses the customer environment attack scenario 420, converts the simulated environment log 410 and generates the customer environment log 430.

The customer environment log generation process corresponds to a log acquisition process and a log conversion process.

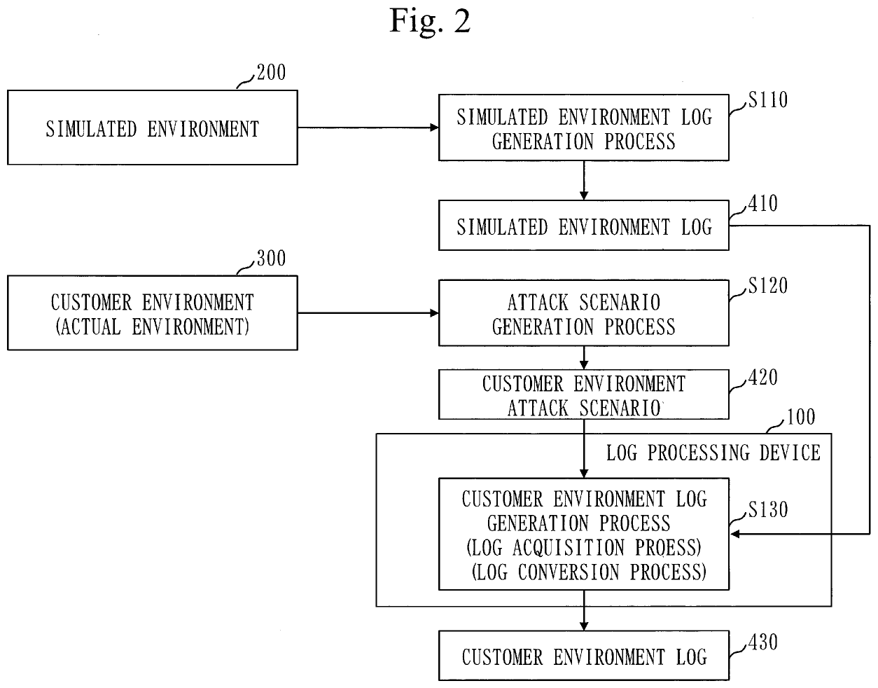

In FIG. 1, the log processing device 100 performs the simulated environment log generation process (Step S110) and the attack scenario generation process (Step S120); however, as illustrated in FIG. 2, the simulated environment log generation process (Step S110) and the attack scenario generation process (Step S120) may be performed outside the log processing device 100.

In the case of FIG. 2, the log processing device 100 acquires from the outside, the simulated environment log 410 acquired in the simulated environment log generation process (Step S110), and the customer environment attack scenario 420 acquired in the attack scenario generation process (Step S120). Then, the log processing device 100 uses the customer environment attack scenario 420 acquired, and converts the simulated environment log 410 acquired into the customer environment log 430.

Hereinafter, description will be made based on the configuration in FIG. 1; however, the following description will be also applied to the configuration in FIG. 2.

### ***Description of Configuration***

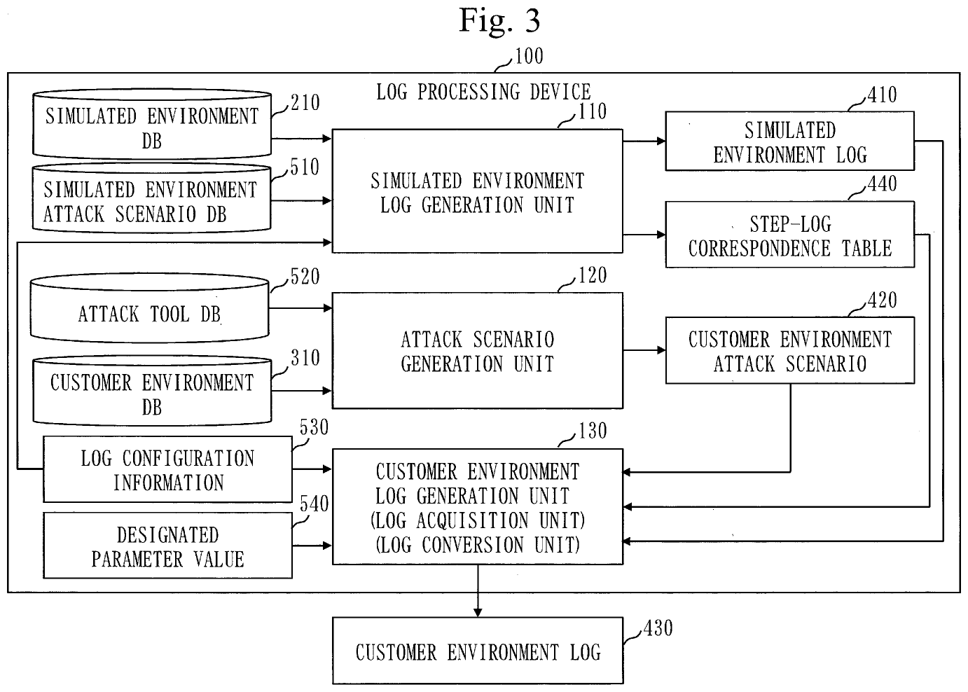

FIG. 3 illustrates an example of a functional configuration of the log processing device 100 according to the present embodiment.

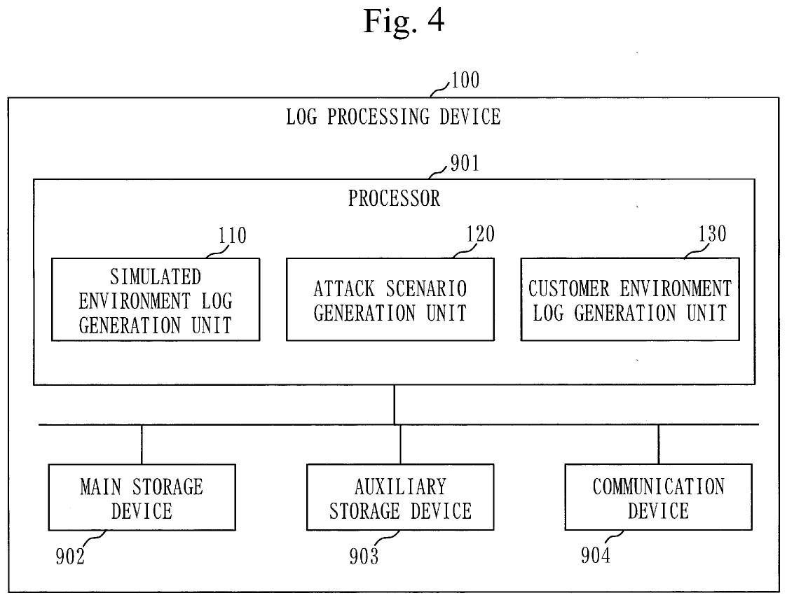

Further, FIG. 4 illustrates an example of a hardware configuration of the log processing device 100 according to the present embodiment.

First, description will be made on the example of the hardware configuration of the log processing device 100 with reference to FIG. 4.

The log processing device 100 according to the present embodiment is a computer.

The log processing device 100 includes a processor 901, a main storage device 902, an auxiliary storage device 903 and a communication device 904, as hardware components.

As illustrated in FIG. 3, the log processing device 100 includes a simulated environment log generation unit 110, an attack scenario generation unit 120 and a customer environment log generation unit 130, as functional components. The functions of the simulated environment log generation unit 110, the attack scenario generation unit 120 and the customer environment log generation unit 130 are realized by programs, for example.

The auxiliary storage device 903 stores the programs to realize the functions of the simulated environment log generation unit 110, the attack scenario generation unit 120 and the customer environment log generation unit 130.

These programs are loaded into the main storage device 902 from the auxiliary storage device 903. Then, the processor 901 executes these programs, and performs operations of the simulated environment log generation unit 110, the attack scenario generation unit 120 and the customer environment log generation unit 130 as described below.

FIG. 4 schematically represents a state wherein the processor 901 executes the programs to realize the functions of the simulated environment log generation unit 110, the attack scenario generation unit 120 and the customer environment log generation unit 130.

Further, a simulated environment DB 210, a simulated environment attack scenario DB 510, an attack tool DB 520 and a customer environment DB 310 illustrated in FIG. 3 are realized by the main storage device 902 or the auxiliary storage device 903.

Next, description will be made on an example of a functional configuration of the log processing device 100, with reference to FIG. 3.

The simulated environment log generation unit 110 performs the simulated environment log generation process (Step S110) illustrated in FIG. 1.

Specifically, the simulated environment log generation unit 110 generates a simulated environment log 410 and a step-log correspondence table 440, using the simulated environment DB 210, the simulated environment attack scenario DB 510 and log configuration information 530.

That is, the simulated environment log generation unit 110 virtually performs on the simulated environment 200 each of a plurality of attack steps constituting a series of attack activities of the Cyber Kill Chain, using the simulated environment DB 210 and the simulated environment attack scenario DB 510. In other words, the simulated environment log generation unit 110 simulates a state of the simulated environment 200 when each of the plurality of attack steps is performed. Then, the simulated environment log generation unit 110 generates a simulated environment log 410 for each attack step. More precisely, the simulated environment log generation unit 110 replaces a simulated environment parameter value included in a difference extraction log 118 to be described later with an abstract representation, using the log configuration information 530, and generates the simulated environment log 410. Hereinafter, both of each simulated environment log generated for each attack step and a set of a plurality of simulated environment logs are written as the simulated environment log 410.

Further, the simulated environment log generation unit 110 also generates the step-log correspondence table 440 correlating the attack steps with the simulated environment logs 410.

The simulated environment log generation unit 110 outputs the simulated environment logs 410 wherein the simulated environment parameter values have been replaced with the abstract representations, and the step-log correspondence table 440, to the customer environment log generation unit 130.

Generation methods of the simulated environment log 410 and the step-log correspondence table 440 by the simulated environment log generation unit 110 can be any methods.

For example, the simulated environment log generation unit 110 executes an attack tool corresponding to each attack step of the attack scenario under the simulated environment 200, and records a timing when the attack tool is executed. Then, the simulated environment log generation unit 110 cuts out logs for a fixed period from the timings recorded (removing a normal log), and stores logs corresponding to the attack steps as the simulated environment logs 410. Further, the simulated environment log generation unit 110 generates correspondence between the attack steps and the corresponding logs, as the step-log correspondence table 440 during the operation.

The simulated environment DB 210 accumulates simulated environment information. The simulated environment information indicates a system configuration, a network configuration and the like of the simulated environment 200.

The simulated environment attack scenario DB 510 accumulates simulated environment attack scenarios. The simulated environment attack scenarios indicate, along with an execution order, the plurality of attack steps constituting the Cyber Kill Chain aiming at the simulated environment 200.

The simulated environment log 410 is a log indicating a behavior estimated to occur in the simulated environment 200 when the simulated environment 200 is attacked, as described above. One or more simulated environment logs 410 are generated for each attack step.

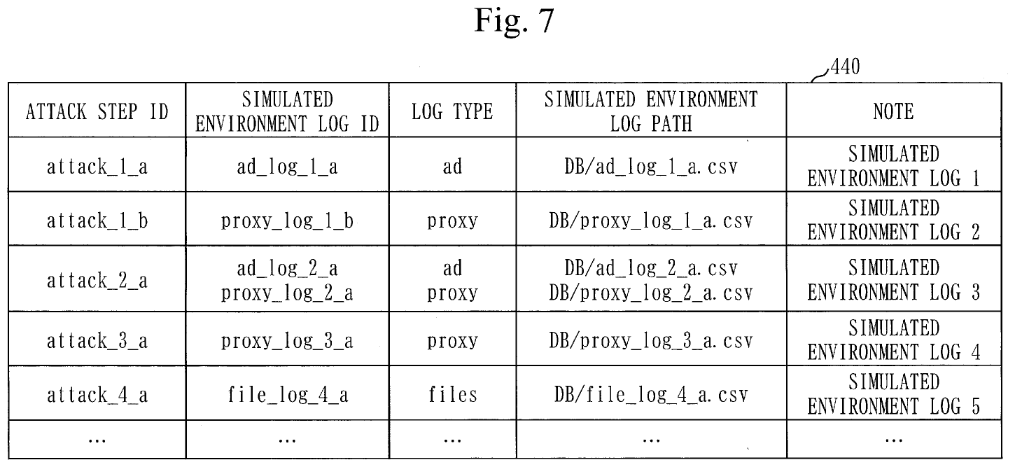

The step-log correspondence table 440 is a correspondence table correlating the attack steps with the simulated environment logs 410. FIG. 7 illustrates an example of the step-log correspondence table 440, for which details will be described below.

The log configuration information 530 indicates a replacement rule from the simulated environment parameter values to the abstract representations.

That is, in the log configuration information 530, simulated environment parameter values being targets of replacement to the abstract representations, and the abstract representations being replacement destinations of the referenced simulated environment parameter values are defined beforehand. The simulated environment parameter values being the replacement targets to the abstract representation are, for example, a domain name, a machine name, a user name, a server name, IP (Internet Protocol) address and the like.

The log configuration information 530 indicates, for example, a replacement rule to replace a concrete description (simulated environment parameter value) of a transmission source IP address in the difference extraction log 118 to be described below, with an abstract representation (symbol notation) of “#Src_IP #”. Further, the log configuration information 530 indicates a replacement rule to replace a concrete description (simulated environment parameter value) of an address domain in the difference extraction log 118 to an abstract representation (symbol notation) of “#Dest_domain #”.

In the present embodiment, description is made on an example wherein the simulated environment attack scenarios have been accumulated in the simulated environment attack scenario DB 510 beforehand when Step S110 is executed. However, the simulated environment log generation unit 110 may cause the attack scenario generation unit 120 to be described below to generate the simulated environment attack scenarios, using the simulated environment DB 210 and the attack tool DB 520, when the simulated environment log generation process (Step S110) is started. In this case, the simulated environment log generation unit 110 uses the simulated environment attack scenarios generated by the attack scenario generation unit 120.

The attack scenario generation unit 120 performs the attack scenario generation process (Step S120) illustrated in FIG. 1.

Specifically, the attack scenario generation unit 120 generates the customer environment attack scenarios 420, using the customer environment DB 310 and the attack tool DB 520. The attack scenario generation unit 120 generates a customer environment attack scenario 420 for each attack step of the Cyber Kill Chain. That is, the attack scenario generation unit 120 generates the customer environment attack scenarios 420 for the same attack steps as attack steps in the simulated environment attack scenario.

Then, the attack scenario generation unit 120 outputs the customer environment attack scenarios 420 generated, to the customer environment log generation unit 130.

In the customer environment attack scenario 420, concrete procedures of attacks that may occur in the customer environment 300 are described. For description of the attack procedures in the customer environment attack scenarios 420, the customer environment parameter values used in the customer environment 300 are used.

The customer environment DB 310 accumulates customer environment information. The customer environment information indicates a system configuration, a network configuration and the like of the customer environment 300.

The attack tool DB 520 is a database to accumulate a plurality of attack tools (scripts). Each attack tool accumulated in the attack tool DB 520 corresponds to each attack step included in a series of attack actions of the Cyber Kill Chain.

That is, the attack scenario generation unit 120 generates the customer environment attack scenario 420 indicating a concrete attack procedure in a case where an attack step specified by an attack tool is executed in the customer environment 300 specified by the customer environment information.

The generation method of the customer environment attack scenario 420 by the attack scenario generation unit 120 can be any generation method. The attack scenario generation unit 120 is capable of generating a customer environment attack scenario 420, using, for example, an attack tree automatic generation technique.

The customer environment log generation unit 130 performs a customer environment log generation process (Step S130) illustrated in FIG. 1.

That is, the customer environment log generation unit 130 acquires the customer environment log 430 by converting the simulated environment log 410, using the customer environment attack scenarios 420, the step-log correspondence table 440, the log configuration information 530 and a designated parameter value 540. In the log configuration information 530, abstract representations to replace the simulated environment parameter values are indicated. The customer environment log generation unit 130 is capable of identifying the abstract representations included in the simulated environment log 410 by referring to the log configuration information 530. Then, the customer environment log generation unit 130 is capable of replacing the abstract representations with the customer environment parameter values included in the customer environment attack scenario 420.

The designated parameter value 540 is a parameter value that is not included in the simulated environment log 410, but should be included in the customer environment log 430.

The customer environment log generation unit 130 replaces the abstract representations in the simulated environment log 410 with the customer environment parameter values, and adds the designated parameter value 540 to the simulated environment log.

Due to replacement of the abstract representations included in the simulated environment log 410 with the customer environment parameter values, and addition of the designated parameter value 540 to the simulated environment log 410, the customer environment log generation unit 130 converts the simulated environment log 410 to the customer environment log 430.

As described, since the customer environment parameter values are described in the customer environment log 430, behaviors estimated to occur in the customer environment 300 when the customer environment 300 is attacked are described correctly.

The customer environment log generation unit 130 corresponds to a log acquisition unit and a log conversion unit. Further, the process performed by the customer environment log generation unit 130 corresponds to a log acquisition process and a log conversion process.

Next, description will be made on an example of an internal configuration of the simulated environment log generation unit 110.

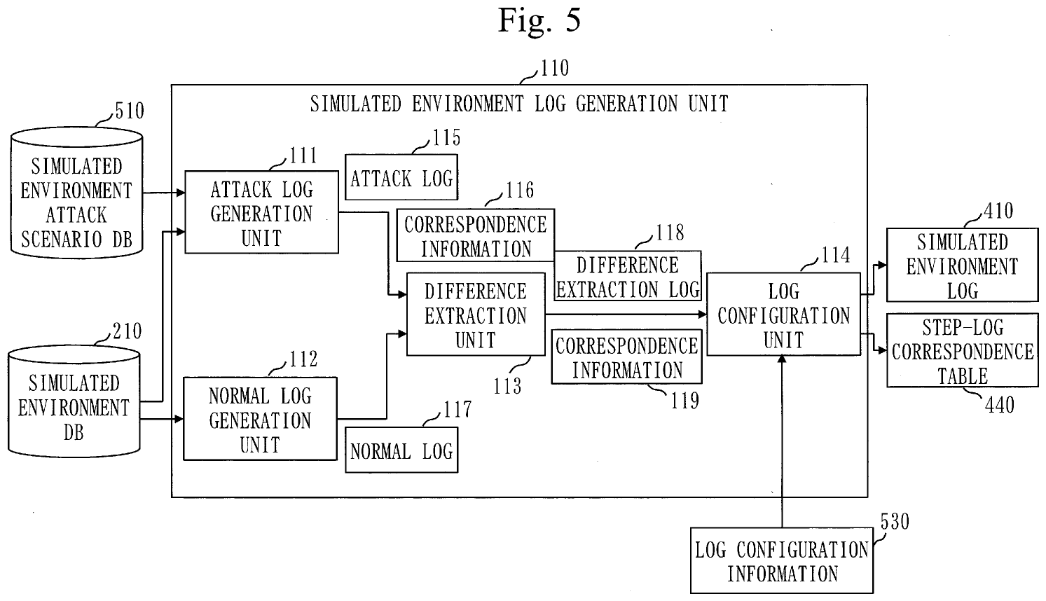

FIG. 5 illustrates the example of the internal configuration of the simulated environment log generation unit 110.

The attack log generation unit 111 generates an attack log 115. The attack log 115 is a log assumed to be generated in the simulated environment 200 when an attack in accordance with the simulated environment attack scenario in the simulated environment attack scenario DB 510 is made on the simulated environment 200.

That is, the attack log generation unit 111 virtually executes the attack in accordance with the simulated environment attack scenario on the simulated environment 200, using the simulated environment attack scenario DB 510 and the simulated environment DB 210. Then, the attack log generation unit 111 generates the attack log 115 indicating a behavior (behavior-under attack) estimated to occur in the simulated environment 200 when the attack is made.

Then, the attack log generation unit 111 outputs the attack log 115 to a difference extraction unit 113.

In the present embodiment, the attack log generation unit 111 shall generate a proxy log, a file server log and an AD log, as the attack logs 115. The clock times of the proxy log, the file server log and the AD log are assumed to be synchronized with one another. The attack log generation unit 111 is capable of generating a log other than these as the attack log 115.

There is a case wherein the attack log 115 includes a behavior (normal behavior) included in a normal log 117 to be described below. That is, a plurality of records included in the attack log 115 may include a record indicating the normal behavior.

Further, the attack log generation unit 111 generates correspondence information 116. The correspondence information 116 indicates a correspondence relation between the attack log 115 and the attack step.

The attack log generation unit 111 generates the attack log 115 for each attack step included in the customer environment attack scenario. The correspondence information 116 indicates which attack step of the plurality of attack steps each of the plurality of attack logs 115 corresponds to.

The attack log generation unit 111 also outputs the correspondence information 116 to the difference extraction unit 113.

The normal log generation unit 112 generates the normal log 117. The normal log 117 is a log assumed to be generated in the simulated environment 200 when the simulated environment 200 is operating normally.

That is, the normal log generation unit 112 generates the normal log 117 indicating a behavior (normal behavior) estimated to occur in the simulated environment 200 when the simulated environment 200 is not subject to attack. The normal behavior is described in each of the plurality of records included in the normal log 117.

In the present embodiment, the normal log generation unit 112 shall generate a proxy log, a file server log and an AD log, as the normal logs 117. The clock times of the proxy log, the file server log and the AD log are assumed to be synchronized with one another.

The normal log generation unit 112 outputs the normal log 117 generated to the difference extraction unit 113.

The difference extraction unit 113 compares the attack log 115 with the normal log 117, and extracts difference between the attack log 115 and the normal log 117, except for values that change every time a process is performed, such as a time stamp, a process ID (Identifier) and the like. Specifically, the difference extraction unit 113 extracts a record different from the record in the normal log 117 from among the plurality of records in the attack log 115.

Then, the difference extraction unit 113 outputs a set of records extracted to the log configuration unit 114, as the difference extraction log 118.

Further, the difference extraction unit 113 corrects correspondence information 116 and generates correspondence information 119, and then outputs the correspondence information 119 to the difference extraction unit 113.

The correspondence information 116 indicates the correspondence relation between the attack step and the attack log 115. The difference extraction unit 113 corrects the correspondence information 116, and generates the correspondence information 119 indicating a correspondence relation between the attack step and the difference extraction log 118.

The difference extraction unit 113 may extract the difference between the attack log 115 and the normal log 117, using an attack detection system learned under the simulated environment 200, or an attack detection system evaluated using the customer environment log 430.

The log configuration unit 114 generates the simulated environment log 410 from the difference extraction log 118. Specifically, the log configuration unit 114 refers to the log configuration information 530, and replaces the customer environment parameter values included in the difference extraction log 118 with the abstract representations. The difference extraction log 118 wherein the customer environment parameter values have been replaced with the abstract representations corresponds to the simulated environment log 410.

Further, the log configuration unit 114 corrects the correspondence information 119, and generates a step-log correspondence table 440.

The correspondence information 119 indicates the correspondence relation between the attack step and the difference extraction log 118. By correcting the correspondence information 119, the log configuration unit 114 generates the step-log correspondence table 440 indicating a correspondence relation between the attack step and the simulated environment log 410.

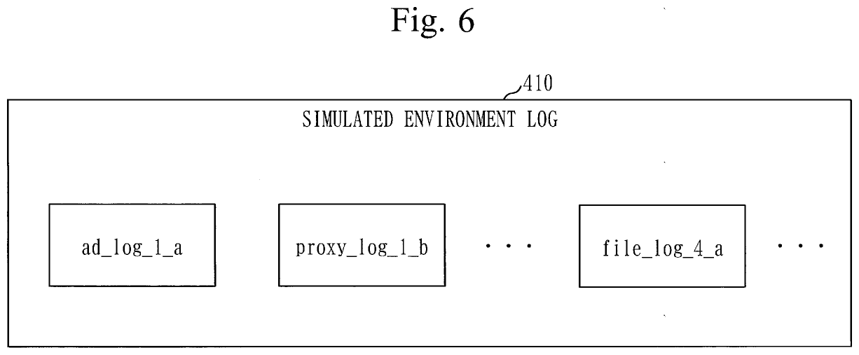

FIG. 6 illustrates an example of the simulated environment log 410. The simulated environment log 410 includes a proxy log, a file server log and an AD log generated for each attack step. It is possible to include a log other than these in the simulated environment log 410.
“ad_log” means an AD log, and “proxy_log” means a proxy log, while “file_log” means a file server log.

FIG. 7 illustrates an example of the step-log correspondence table 440. The step-log correspondence table 440 indicates a correspondence relation between the attack step and the simulated environment log 410.

The step-log correspondence table 440 includes an attack step ID, a simulated environment log ID, a log type, a simulated environment log path and a note.

The attack step ID is an identifier whereby the attack steps in the simulated environment attack scenarios can be uniquely identified.

The simulated environment log ID is an identifier whereby the simulated environment logs 410 can be uniquely identified.

The log type represents types of the simulated environment logs 410. In the present embodiment, there exist an AD log, a proxy log and a file server log, as the log types.

The simulated environment log path describes a file path to the simulated environment logs 410.

The note describes reference information of the simulated environment logs 410.

In the example of FIG. 7, two simulated environment logs 410 of “ad_log_2_a” and “proxy_log_2_a” are generated in the attack step of “attack step ID: attack_2_a”. Like this, there is a case wherein two or more simulated environment logs 410 are generate for one attack step.

Next, description will be made on an example of an internal configuration of the customer environment log generation unit 130.

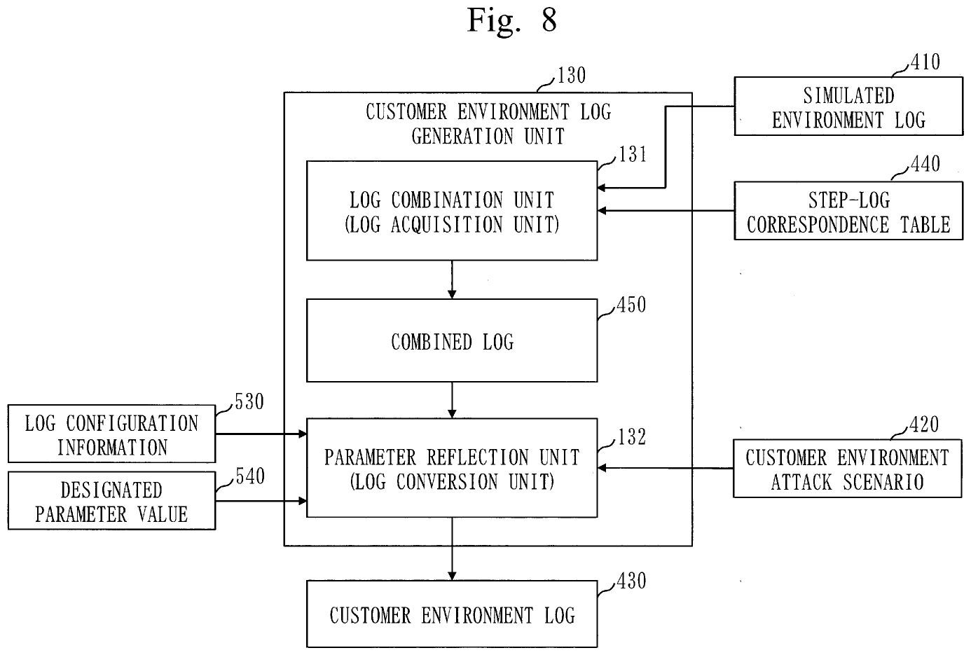

FIG. 8 illustrates the example of the internal configuration of the customer environment log generation unit 130.

A log combination unit 131 acquires the simulated environment logs 410 and the step-log correspondence table 440.

Then, the log combination unit 131 combines the simulated environment log 410 for each attack step in accordance with the step-log correspondence table 440. That is, when two or more simulated environment logs 410 are generated for the same attack step, the log combination unit 131 correlates two or more simulated environment logs 410 generated for the same attack step with one another. In the example of FIG. 7, two simulated environment logs 410 of “ad_log_2_a” and “proxy_log_2_a” are generated for the attack step of “attack step ID: attack_2_a”. Therefore, the log combination unit 131 correlates these two simulated environment logs 410 with each other.

Then, the log combination unit 131 outputs the simulated environment logs 410 after being combined, as a combined log 450. Hereinafter, each combined log and a set of a plurality of combined logs are also written as the combined log 450.

The log combination unit 131 corresponds to a log acquisition unit. Additionally, the process performed by the log combination unit 131 corresponds to a log acquisition process.

A parameter reflection unit 132 acquires the customer environment attack scenario 420, the combined log 450, the log configuration information 530 and the designated parameter value 540.

Then, the parameter reflection unit 132 refers to the log configuration information 530, and replaces the abstract representations included in each combined log 450 with the customer environment parameter values included in the customer environment attack scenario 420. The parameter reflection unit 132 replaces, for example, “#Src_IP #” being an abstract representation of a transmission source IP address with a concrete IP address “x. x. x. x” being a customer environment parameter value. Further, the parameter reflection unit 132 replaces “#Dest_domain #” being an abstract representation of a destination domain with a concrete domain name “yyy. zzz. jp” being a customer environment parameter value.

The description except for the abstract representations in the combined log 450 is the same as the description except for the customer environment parameter values of the customer environment attack scenario 420. Therefore, by scanning the combined log 450 and the customer environment attack scenario 420, the parameter reflection unit 132 is capable of extracting a customer environment parameter value corresponding to the abstract representation in the combined log 450 from the customer environment attack scenario 420.

Further, the parameter reflection unit 132 adds a designated parameter value 540 to the combined log 450. The designated parameter value 540 is, for example, a value of an attack step interval, a file name and the like.

Then, the parameter reflection unit 132 outputs, as a customer environment log 430, the combined log 450 wherein the abstract representations included in the combined log 450 have been replaced with the customer environment parameter values, and the designated parameter value 540 has been added to the simulated environment log 410.

### Description of Operation

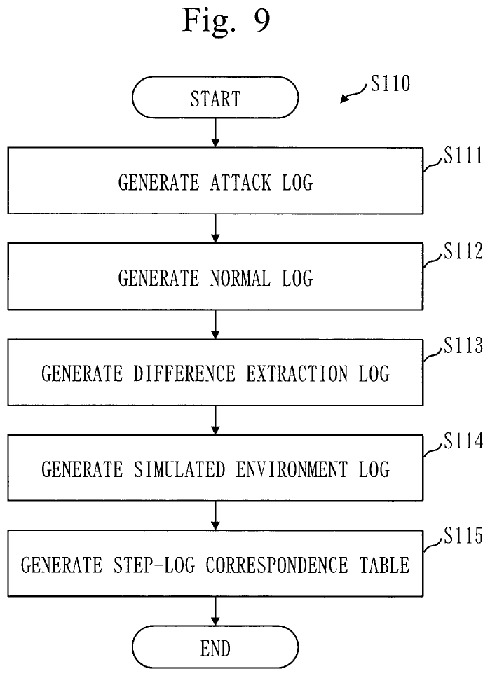

Next, description will be made on a simulated environment log generation process (Step S110) in detail, with reference to FIG. 9.

First, in Step S111, the attack log generation unit 111 refers to the simulated environment attack scenario DB 510 and the simulated environment DB 210, virtually makes an attack on the simulated environment 200 in accordance with the simulated environment attack scenario, and generates the attack log 115.

The attack log generation unit 111 may generate the attack log 115 focused on an event from a doer of the attack, based on information on a transmission source IP address, a user name and the like described in the simulated environment attack scenario.

Further, the attack log generation unit 111 also generates the correspondence information 116.

Then, the attack log generation unit 111 outputs the attack log 115 and the correspondence information 116 generated, to the difference extraction unit 113.

Next, in Step S112, the normal log generation unit 112 refers to the simulated environment DB 210, and generates a normal log 117. The normal log generation unit 112 generates the normal log 117 after restoring the simulated environment 200 to a clean state before being attacked by the attack log generation unit 111.

Then, the normal log generation unit 112 outputs the normal log 117 to the difference extraction unit 113.

In FIG. 9, Step S112 is performed after Step S111; however, Step S112 may be performed prior to Step S111.

Further, Step S111 may be performed concurrently with Step S112.

Next, in Step S113, the difference extraction unit 113 generates the difference extraction log 118.

Specifically, the difference extraction unit 113 compares the attack log 115 with the normal log 117, removes values that change every time a process is performed, such as a time stamp, a process ID and the like, and extracts the difference between the attack log 115 and the normal log 117. That is, the difference extraction unit 113 extracts a record different from the record in the normal log, from among a plurality of records in the attack log 115.

Then, the difference extraction unit 113 outputs a set of the records extracted to the log configuration unit 114, as the difference extraction log 118.

Further, the difference extraction unit 113 generates the correspondence information 119 from the correspondence information 116.

Next, in Step S114, the log configuration unit 114 generates the simulated environment log 410 from the difference extraction log 118. Specifically, the log configuration unit 114 refers to the log configuration information 530, and replaces the customer environment parameter values included in the difference extraction log 118 with the abstract representations.

The log configuration unit 114 converts, for example, a concrete description (simulated environment parameter value) of a transmission source IP address into an abstract representation of “#Src_IP #”. Further, the log configuration unit 114 converts, for example, a concrete description (simulated environment parameter value) of an AD server name into an abstract representation of “#AD_Server #”.

Further, when the same simulated environment parameter value appears repeatedly in the difference extraction log 118, the log configuration unit 114 replaces each simulated environment parameter value with the same abstract representation. For example, when a transmission source IP address “r. r. r. r” appears repeatedly in the difference extraction log 118, the log configuration unit 114 converts each into the same abstract representation “#Src_IP #”.

Further, when a plurality of different values appear for parameters of the same type in the difference extraction log 118, numbers are assigned to variables in the appearing order of the parameters of the same type. For example, it is supposed a case wherein “r. r. r. r”, “s. S. S. s” and “t. t. t. t” appear as transmission source IP addresses in the difference extraction log 118. In this case, the log configuration unit 114 replaces each of “r. r. r. r”, “s. S. S. s” and “t. t. t. t” with “#Src_IP_1 #”, “#Src_IP_2 #” and “#Src_IP_3 #”.

Further, in Step S115, the log configuration unit 114 generates the step-log correspondence table 440 from the correspondence information 119.

That is, the log configuration unit 114 corrects the correspondence information 119, and generates the step-log correspondence table 440 indicating the correspondence relation between the attack step and the simulated environment log 410.

Then, the log configuration unit 114 outputs the simulated environment logs 410 and the step-log correspondence table 440 to the customer environment log generation unit 130.

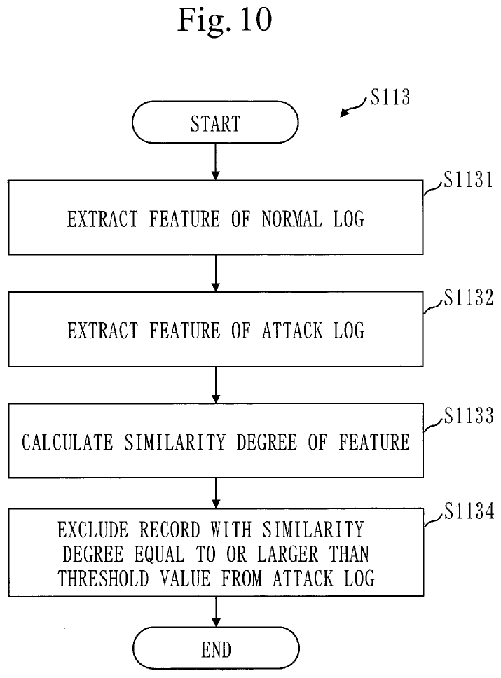

Next, description will be made on Step S113 in detail, with reference to FIG. 10.

First, in Step S1131, the difference extraction unit 113 extracts features of each record in the normal log 117. Difference extraction is a process to confirm whether a record in the normal log remains in the attack log. Therefore, the difference extraction unit 113 extracts the features of each record. The difference extraction unit 113 refers to a column (field) of each record, and extracts the features.

The features that should be extracted shall be defined beforehand for each type of the normal log 117. The difference extraction unit 113 extracts the features defined beforehand, for each type of the normal log 117.

When the normal log 117 is a proxy log, the difference extraction unit 113 extracts, for example, the features of a request URL (Uniform Resource Locator), a status code, a reception size and a user agent, from the normal log 117 (proxy log).

Next, in Step S1132, the difference extraction unit 113 extracts features of each record in the attack log 115.

The difference extraction unit 113 extracts the same features as those of the normal logs 117 of the same type, from the attack log 115. For example, when the attack log 115 is a proxy log, the difference extraction unit 113 extracts, for example, features of a request URL, a status code, a reception size and a user agent, as with the normal log 117, from the attack log 115 (proxy log).

In FIG. 10, Step S1132 is performed after Step S1131; however, Step S1132 may be performed prior to Step S1131.

Further, Step S1131 may be performed concurrently with Step S1132.

Next, in Step S1133, the difference extraction unit 113 calculates degrees of similarity in features with each record of the normal logs 117, for each record of the attack log 115.

Step S1133 is performed between the attack log 115 and the normal logs 117 of the same type. That is, a degree of similarity with each record in the normal log 117 being the proxy log is calculated for each record in the attack log 115 being the proxy log.

Specifically, the difference extraction unit 113 calculates a similarity degree by a technique such as a cosine distance, Euclidean distance or the like. In a case of a character string such as a domain, etc., the difference extraction unit 113 calculates the similarity degree by converting the character string into a numeric representation with a technique such as BoW (Bag of Words), etc.

Next, in Step S1134, the difference extraction unit 113 excludes a record of the attack log 115 having a similarity degree with any record in the normal log 117 equal to or larger than a threshold value, from the referenced attack log 115.

The difference extraction unit 113 performs Step S1134 on each record of the attack log 115.

The attack log 115 wherein the record having the similarity degree equal to or larger than the threshold value has been excluded in Step S1134, that is, a log constituted by records not having similarity with the records in the normal log 117 corresponds to the difference extraction log 118.

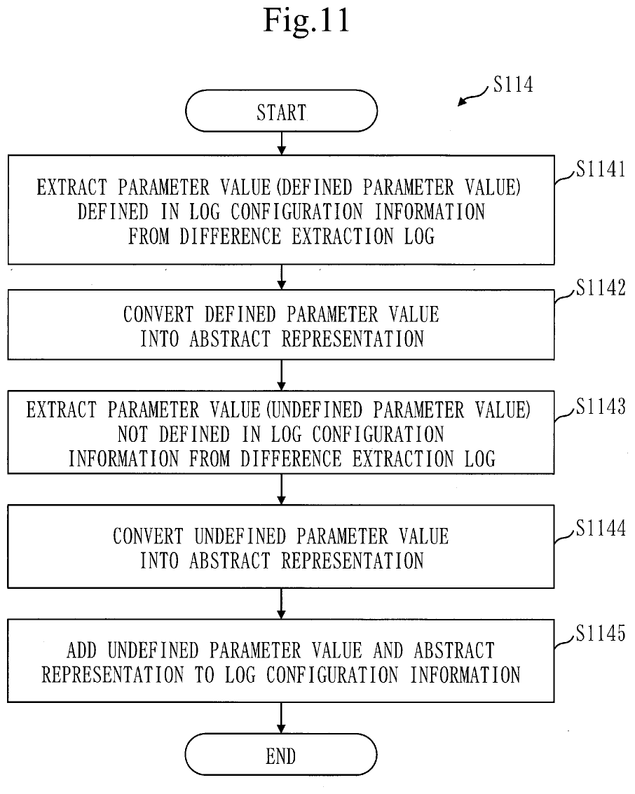

Next, description will be made on Step S114 in detail, with reference to FIG. 11.

First, in Step S1141, the log configuration unit 114 extracts a simulated environment parameter value (defined parameter value) defined in the log configuration information 530 from the difference extraction log 118.

That is, the log configuration unit 114 extracts, from the difference extraction log 118, the simulated environment parameter value defined to be replaced with the abstract representation in the log configuration information 530, as a defined parameter value.

Next, in Step S1142, the log configuration unit 114 replaces the defined parameter value with the abstract representation.

As described, when the same defined parameter value appears repeatedly in the difference extraction log 118, the log configuration unit 114 converts each defined parameter value into the same abstract representation. Further, when a plurality of different values appear for the parameters of the same type in the difference extraction log 118, numbers are assigned to variables in the appearing order of the parameters of the same type.

Next, in Step S1143, the log configuration unit 114 extracts, from the difference extraction log 118, a parameter value (undefined parameter value), which is a simulated environment parameter value that is not defined in the log configuration information 530, and which is included in the customer environment log 430.

That is, the log configuration unit 114 extracts, from the difference extraction log 118, the simulated environment parameter value, which is not defined in the log configuration information 530, and which should be replaced with an abstract representation, as the undefined parameter value.

Next, in Step S1144, the log configuration unit 114 replaces the undefined parameter value with the abstract representation. The abstract representation with which the undefined parameter value is replaced is a default value. The log configuration unit 114 converts, in the appearing order of undefined parameter values, each of the undefined parameter values to a default abstract representation such as “#undefined_1 #”, “#undefined_2 #”, and “#undefined 3 #”.

Next, in Step S1145, the log configuration unit 114 adds the undefined parameter values and the corresponding abstract representations to the log configuration information 530.

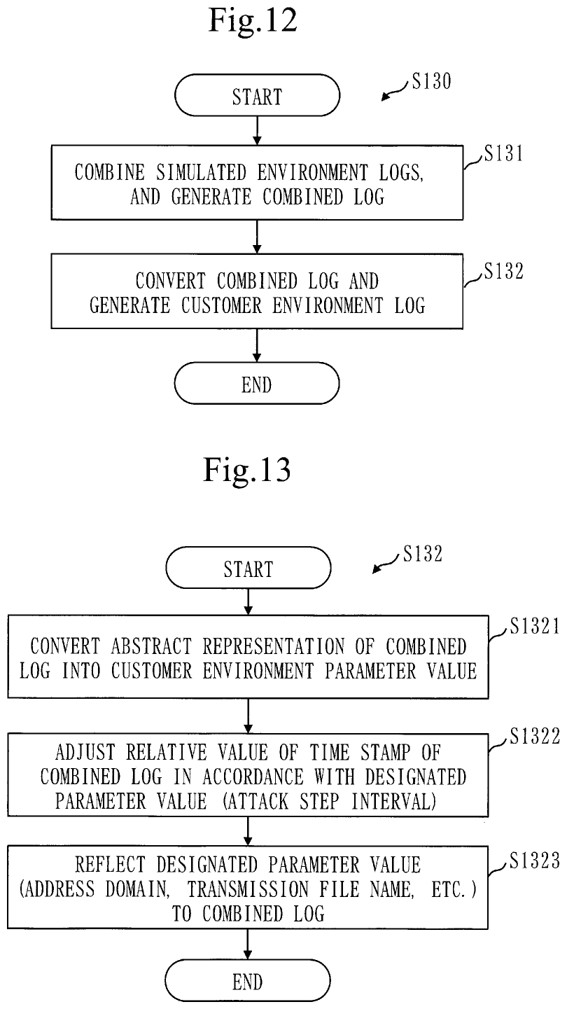

Next, description will be made on a customer environment log generation process (Step S130) in detail, with reference to FIG. 12.

Since the attack scenario generation process (Step S120) can be realized using an existing attack tree automatic generation technique, detailed description thereof is omitted.

First, in Step S131, the log combination unit 131 combines the simulated environment logs 410, and generates the combined log 450.

Specifically, the log combination unit 131 combines the simulated environment logs 410 for each attack step, in accordance with the step-log correspondence table. That is, the log combination unit 131 correlates two or more simulated environment logs 410 generated for the same attack step with one another.

Next, in Step S132, the parameter reflection unit 132 converts the combined log 450, and generates the customer environment log 430.

Specifically, the parameter reflection unit 132 refers to the log configuration information 530, and converts the abstract representation included in the combined log 450 into the customer environment parameter value included in the customer environment attack scenario 420.

Next, description will be made on Step S1321 in detail, with reference to FIG. 13.

First, in Step S1321, the parameter reflection unit 132 replaces the abstract representation in the combined log 450 with the customer environment parameter value.

That is, the parameter reflection unit 132 refers to the log configuration information 530, and identifies the abstract representation in the combined log 450. Then, the parameter reflection unit 132 specifies a customer environment parameter value of the customer environment attack scenario 420 existing at a position corresponding to the abstract representation identified. Further, the parameter reflection unit 132 replaces the abstract representation in the combined log 450 with the customer environment parameter value specified.

The parameter reflection unit 132 performs these operations on all the abstract representations in all the combined logs 450.

Next, in Step S1322, the parameter reflection unit 132 adjusts relative values of time stamps in the combined logs 450 in accordance with an attack step interval designated in the designated parameter value 540.

That is, when the interval (attack step interval) between the attack steps is designated in the designated parameter value 540, the parameter reflection unit 132 adjusts the time stamps (relative values), and reconfigures the combined log 450 with the time stamps after being adjusted.

In the designated parameter value 540, there is a case wherein a random value (a mean value and a standard deviation are designated) or a fixed value is designated as the attack step interval, for each attack step. When the random value is designated as the attack step interval in the designated parameter value 540, the parameter reflection unit 132 adjusts a time interval between records corresponding to relevant attack steps with the random number based on the mean value and the standard deviation designated. Further, when the fixed value is designated as the attack step interval in the designated parameter value 540, the parameter reflection unit 132 adjusts the time interval between records corresponding to the relevant attack steps in accordance with the fixed value designated.

Next, in Step S1323, the parameter reflection unit 132 reflects an address domain, a transmission file name and the like designated in the designated parameter value 540 to the combined log 450.

In the designated parameter value 540, there is a case wherein an address domain, a transmission file name, a proxy server and the like are designated for each attack step. When these are designated in the designated parameter values 540, the parameter reflection unit 132 corrects relevant items in the combined logs 450. For example, the parameter reflection unit 132 reflects the values designated in the designated parameter value 540, for each attack step, to the combined log 450, in such a manner as “#Dest_Domain #=malicious. com”, and “#Upload_file #-confidential. doc”.

Next, description will be made on an operation example of the log processing device 100 according to the present embodiment, using a concrete example.

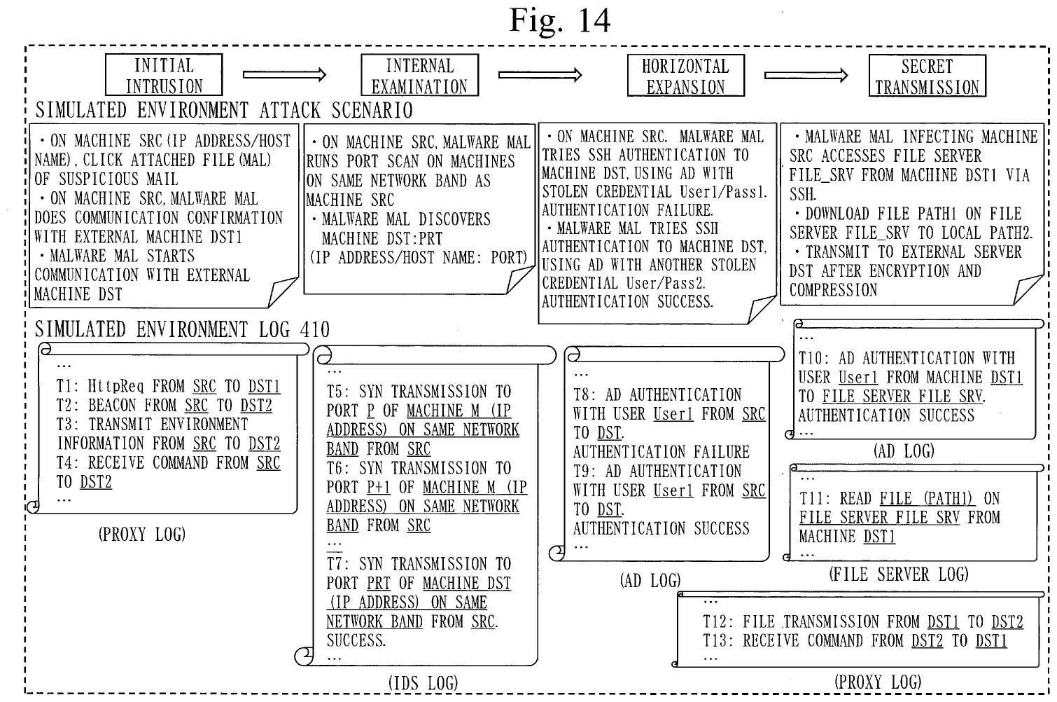

FIG. 14 illustrates an example of the simulated environment attack scenario accumulated in the simulated environment attack scenario DB 510, and an example of the simulated environment log 410 generated by the simulated environment log generation unit 110 in accordance with the simulated environment attack scenario.

In the simulated environment attack scenario of FIG. 14, “initial intrusion”, “internal examination”, “horizontal expansion” and “secret transmission” are defined as the attack steps to the simulated environment 200.

In the simulated environment attack scenario, attack procedures in each of “initial intrusion”, “internal expansion” and “secret transmission” are described.

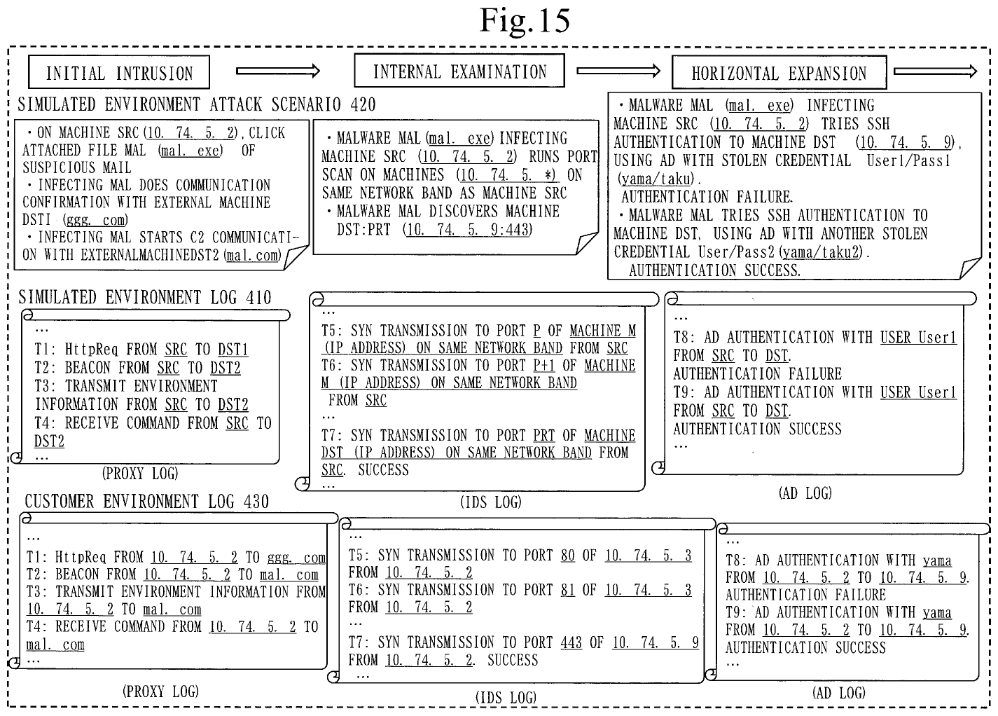

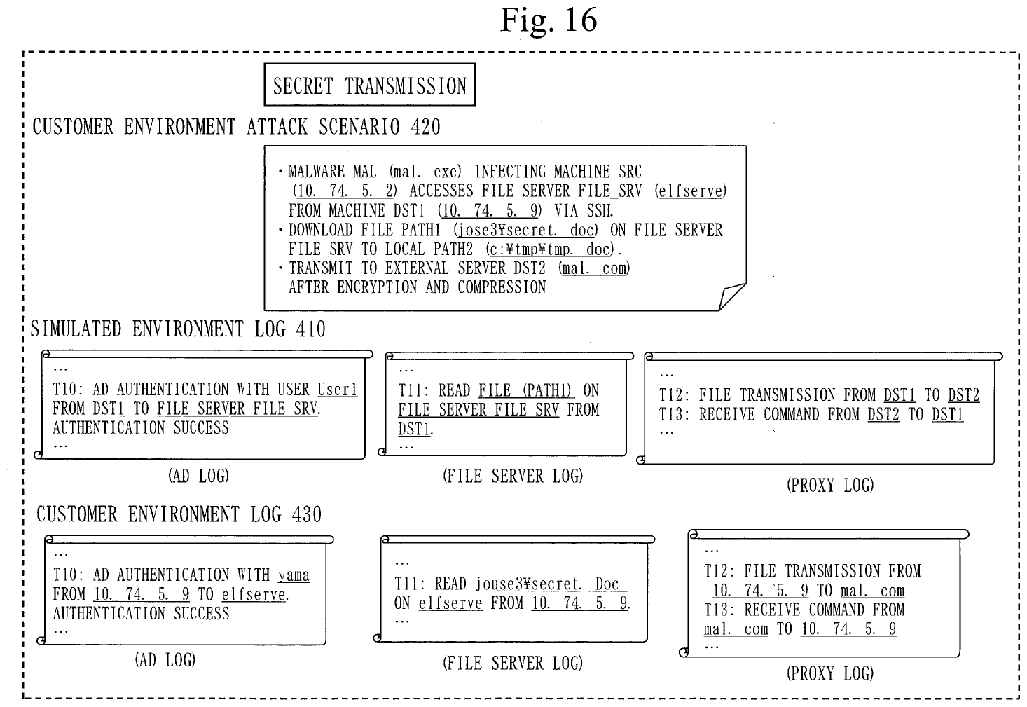

In the simulated environment log 410, each of “T1” through “T13” indicates a time stamp. In FIG. 15 and FIG. 16 as well, each of “T1” through “T13” indicates a time stamp. Each line corresponding to “T1” through “T13” in the simulated environment log 410 is a record in the simulated environment log 410.

In the simulated environment log 410, a behavior that occurs in the simulated environment 200 in response to the attack step in the simulated environment attack scenario is described in each record.

Further, in FIG. 14, the simulated environment log 410 corresponding to each attack step in the simulated environment attack scenario is described below each attack step. In the example of FIG. 14, the simulated environment log generation unit 110 generates a proxy log in response to “initial intrusion”. Further, the simulated environment log generation unit 110 generates an IDS (Intrusion Detection System) log in response to “internal examination”. In addition, the simulated environment log generation unit 110 generates an AD log in response to “horizontal expansion”. Furthermore, the simulated environment log generation unit 110 generates an AD log, a file server log and a proxy log in response to “secret transmission”.

In FIG. 14, the simulated environment parameter value is replaced with the abstract representation in the simulated environment log 410. In FIG. 14, for example, underlined items such as “SRC”, “DST1” and “DST2”, etc. are abstract representations. In FIG. 14, phrases such as “machine M (IP address) in the same network band”, “port P”, “file server FILE_SRV” and “user USER1” are added to a part of the items, for simplifying description. In an actual operation, these are also described in the abstract representations excluding explanatory phrases, in such a manner as “M”, “P”, “FILE_SRV”, “user USER1” and the like.

FIG. 15 and FIG. 16 illustrate examples of the customer environment attack scenario 420, the simulated environment log 410 and the customer environment log 430.

FIG. 15 illustrates examples of the customer environment attack scenario 420, the simulated environment log 410 and the customer environment log 430 with respect to “initial intrusion”, “internal examination” and “horizontal expansion”. FIG. 16 illustrates examples of the customer environment attack scenario 420, the simulated environment log 410 and the customer environment log 430 with respect to “secret transmission”.

The simulated environment logs 410 in FIG. 15 and FIG. 16 are the same as the simulated environment log 410 illustrated in FIG. 14.

As described in FIG. 15 and FIG. 16, the parameter reflection unit 132 replaces the abstract representations (underlined parts) in the simulated environment log 410 with the customer environment parameter values (underlined parts) in the customer environment attack scenario 420.

For example, in FIG. 15, “SRC” in the simulated environment log 410 corresponds to “SRC” of “machine SRC (10. 74. 5. 2)” in the customer environment attack scenario 420. Therefore, the parameter reflection unit 132 replaces “SRC” in the simulated environment log 410 with “10. 74. 5. 2” in the customer environment attack scenario 420. Similarly, “DST1” in the simulated environment log 410 corresponds to “external machine DST1 (ggg. com)” in the customer environment attack scenario 420. Therefore, the parameter reflection unit 132 replaces “DST1” in the simulated environment log 410 with “ggg. com” in the customer environment attack scenario 420.

As a result, “HttpReq from SRC to DST1” of “T1” in the simulated environment log 410 is replaced with “HttpReq from 10. 74. 5. 2 to ggg. com” in the customer environment log 430. The parameter reflection unit 132 replaces other abstract representations in the simulated environment log 410 with the customer environment parameter values indicated in the corresponding descriptions in the customer environment attack scenario 420.

In FIG. 15 and FIG. 16, reflection of the designated parameter values 540 to the customer environment log 430 is omitted.

### Description of Effect of Embodiment

As described above, according to the present embodiment, it is possible to acquire the customer environment log 430 indicating behaviors in the customer environment when the customer environment is attacked without adversely affecting the customer environment.

Therefore, according to the present embodiment, it is possible to construct an attack detection system to protect the customer environment 300 against a cyberattack by analyzing the customer environment log 430.

In the present embodiment, description has been made on an example wherein the log configuration unit 114 replaces the simulated environment parameter values in the simulated environment log 410 with the abstract representations. The log configuration unit 114 may not replace the simulated environment parameter values in the simulated environment log 410 with the abstract representations. That is, the log configuration unit 114 may output the simulated environment log 410 wherein the simulated environment parameter values are described, to the customer environment log generation unit 130. In this case, not the abstract representations but the simulated environment parameter values are described in the log configuration information 530. Then, the parameter reflection unit 132 replaces the simulated environment parameter values in the simulated environment log 410 with the corresponding customer environment parameter values in accordance with the log configuration information 530.

### Second Embodiment

In the present embodiment, description will be made mainly on differences from First Embodiment.

Items not described below are the same as those in First Embodiment.

### ***Description of Configuration***

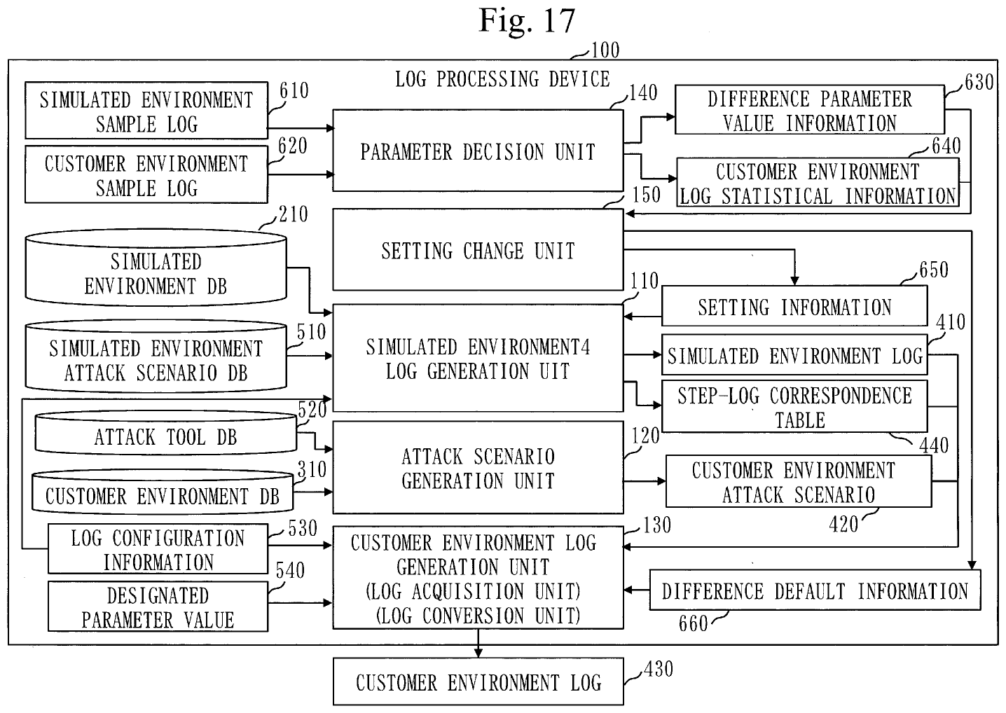

FIG. 17 illustrates an example of a functional configuration of the log processing device 100 according to the present embodiment.

In FIG. 17, in comparison to FIG. 3, a parameter decision unit 140, a setting change unit 150, a simulated environment sample log 610, a customer environment sample log 620, difference parameter value information 630, customer environment log statistical information 640, setting information 650 and difference default information 660 are added.

Hereinafter, description will be made mainly on the parameter decision unit 140, the setting change unit 150, the simulated environment sample log 610, the customer environment sample log 620, the difference parameter value information 630, the customer environment log statistical information 640, the setting information 650 and the difference default information 660.

An example of the hardware configuration of the log processing device 100 according to the present embodiment is as illustrated in FIG. 4.

The parameter decision unit 140 and the setting change unit 150 are realized by programs as with the customer environment log generation unit 130, etc. The processor 901 executes the programs to realize the functions of the parameter decision unit 140 and the setting change unit 150, and performs operations of the parameter decision unit 140 and the setting change unit 150 to be described below.

The parameter decision unit 140 decides whether an abstract representation corresponding to a customer environment parameter value requested to be described in the customer environment log 430 (hereinafter referred to as a requested customer environment parameter value) is described in the simulated environment log 410. The abstract representation corresponding to the requested customer environment parameter value is an abstract representation capable of including the requested customer environment parameter value in the customer environment log 430 by replacement in Step S1321 illustrated in FIG. 13.

The requested customer environment parameter value corresponds to a requested actual environment parameter value.

More specifically, the parameter decision unit 140 acquires the simulated environment sample log 610 and the customer environment sample log 620. Then, the parameter decision unit 140 decides whether a parameter value not included in the simulated environment sample log 610 but included in the customer environment sample log 620 exists. When the parameter value not included in the simulated environment sample log 610 but included in the customer environment sample log 620 exists, the parameter decision unit 140 decides that the abstract representation corresponding to the requested customer environment parameter value is not described in the simulated environment log 410. Then, the parameter decision unit 140 outputs, to the setting change unit 150, the difference parameter value information 630 wherein the parameter value not included in the simulated environment sample log 610 but included in the customer environment sample log 620 is indicated as the requested customer environment parameter value.

Further, the parameter decision unit 140 calculates statistical values of the parameter values included in the customer environment sample log 620, and generates the customer environment log statistical information 640 indicating the statistical values calculated. Then, the parameter decision unit 140 outputs the customer environment log statistical information 640 generated to the setting change unit 150.

The simulated environment sample log 610 is a sample log acquired in the simulated environment 200. The simulated environment sample log 610 is, for example, a normal log 117 acquired in the past.

The customer environment sample log 620 is a sample log acquired in the customer environment 300. The customer environment sample log 620 is, for example, a log corresponding to the normal log 117, which has been acquired in the past in the customer environment 300. That is, the customer environment sample log 620 is a log generated in the customer environment 300 when the customer environment 300 operates normally.

In the difference parameter value information 630, as the requested customer environment parameter value, the parameter value not included in the simulated environment sample log 610 but included in the customer environment sample log 620 is indicated, as described above.

In the customer environment log statistical information 640, as described above, the statistical values of the parameter values included in the customer environment sample log 620 are indicated.

When the parameter values are category data, in the customer environment log statistical information 640, appearance frequencies of unique character strings included in the parameter values are indicated, as the statistical values. Meanwhile, when the parameter values are numerical value data, in the customer environment log statistical information 640, a mean value and dispersion of numerical values and the like are indicated, as the statistical values.

When it is decided that the abstract representation corresponding to the requested customer environment parameter value is not described in the simulated environment log 410 by the parameter decision unit 140, the setting change unit 150 changes the setting of the simulated environment log 410 so that the abstract representation corresponding to the requested customer environment parameter value is made to be described in the simulated environment log 410.

That is, when the difference parameter value information 630 is output, the setting change unit 150 changes the setting of the simulated environment log 410. More specifically, the setting change unit 150 refers to the customer environment log statistical information 640, and generates the setting information 650 to change the setting of the simulated environment log 410. Then, the setting change unit 150 outputs the setting information 650 generated, to the simulated environment log generation unit 110. The setting information 650 is a command to instruct the simulated environment log generation unit 110 to describe the abstract representation corresponding to the requested customer environment parameter value in the simulated environment log 410.

Further, when the abstract representation corresponding to the requested customer environment parameter value is not described in the simulated environment log 410 with the setting information 650, the setting change unit 150 makes the customer environment log generation unit 130 describe a substitute value of the requested customer environment parameter value in the simulated environment log 410 (to be more precise, the combined log 450; hereinafter the same shall apply). Specifically, the setting change unit 150 outputs the difference default information 660 to the customer environment log generation unit 130, and makes the customer environment log generation unit 130 describe the substitute value of the requested customer environment parameter value in the simulated environment log 410.

The difference default information 660 is a command to instruct the customer environment log generation unit 130 to describe the substitute value of the requested customer environment parameter value in the simulated environment log 410. In the difference default information 660, the substitute value calculated based on the statistical value indicated in the customer environment log statistical information 640 is indicated.

In the present embodiment, the simulated environment log generation unit 110 describes the abstract representation corresponding to the requested customer environment parameter value in the simulated environment log 410 in accordance with the setting information 650.

Further, in the present embodiment, the customer environment log generation unit 130 describes the substitute value of the requested customer environment parameter value in the simulated environment log 410 in accordance with the difference default information 660.

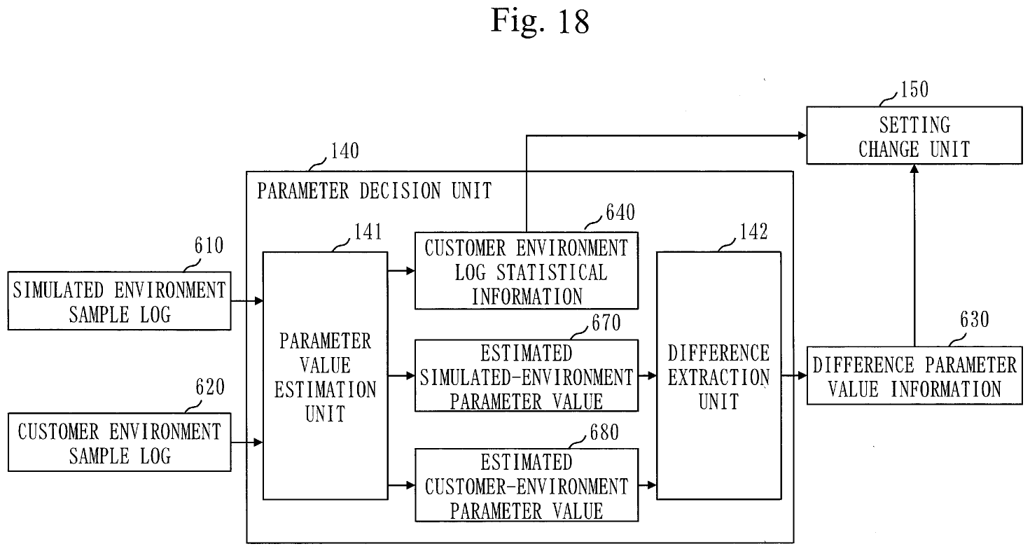

FIG. 18 illustrates an example of the internal configuration of the parameter decision unit 140.

The parameter value estimation unit 141 analyzes the simulated environment sample log 610, and estimates the simulated environment parameter values included in the simulated environment log 410. Then, the parameter value estimation unit 141 outputs the simulated environment parameter values acquired by estimation to the difference extraction unit 142, as estimated simulated-environment parameter values 670.

Further, the parameter value estimation unit 141 analyzes the customer environment sample log 620, and estimates the customer environment parameter values included in the customer environment log 430. Then, the parameter value estimation unit 141 outputs the customer environment parameter values acquired by estimation to the difference extraction unit 142, as estimated customer-environment parameter values 680.

Furthermore, the parameter value estimation unit 141 calculates statistical values of the estimated customer-environment parameter values 680, and generates customer environment log statistical information 640 indicating the statistical values of the estimated customer-environment parameter values 680 calculated. Then, the parameter value estimation unit 141 outputs the customer environment log statistical information 640 generated, to the setting change unit 150.

As described above, when the estimated customer-environment parameter values 680 are category data, the parameter value estimation unit 141 calculates appearance frequencies of unique character strings included in the estimated customer-environment parameter values 680, as the statistical values. Meanwhile, when the estimated customer-environment parameter values 680 are numerical value data, the parameter value estimation unit 141 calculates a mean value, deviation and the like of the numerical values, as the statistical values.

The difference extraction unit 142 compares the estimated simulated-environment parameter values 670 with the estimated customer-environment parameter values 680. Then, when an estimated customer-environment parameter value 680 different from the estimated simulated-environment parameter values 670 exists, the parameter decision unit 140 extracts the relevant estimated customer-environment parameter value as the requested customer environment parameter value. Additionally, the parameter decision unit 140 outputs difference parameter value information 630 indicating the requested customer environment parameter value extracted, to the setting change unit 150.

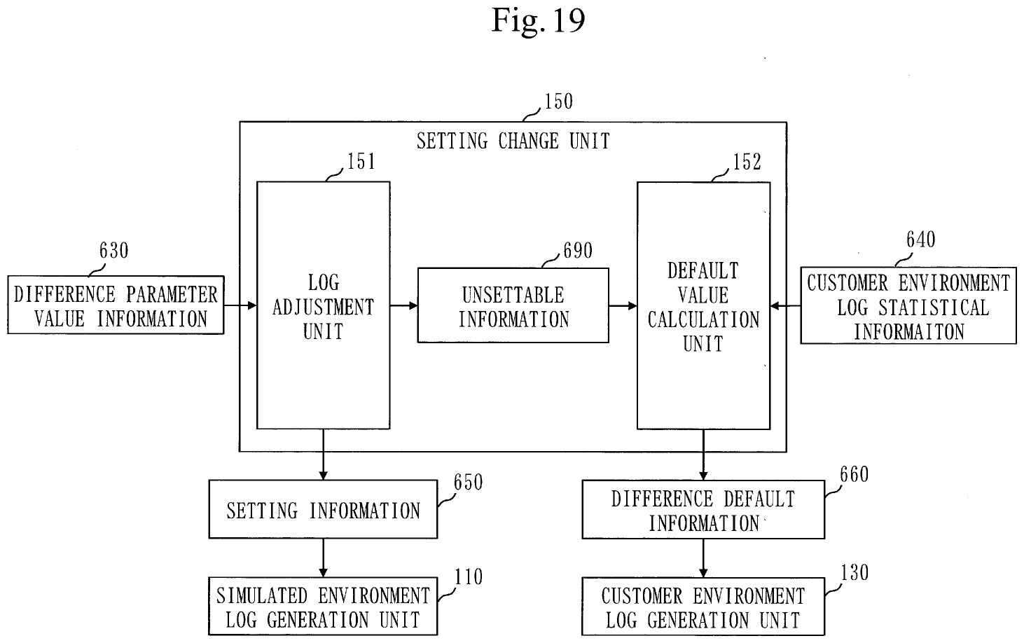

FIG. 19 illustrates an example of the internal configuration of the setting change unit 150.

The log adjustment unit 151 acquires the difference parameter value information 630. Then, the log adjustment unit 151 decides whether it is possible to describe by the simulated environment log generation unit 110, in the simulated environment log 410, the abstract representations corresponding to all the requested customer environment parameter values indicated in the difference parameter value information 630.

When it is not possible to describe an abstract representation corresponding to any of the requested customer environment parameter values in the simulated environment log 410 by the simulated environment log generation unit 110, the log adjustment unit 151 outputs unsettable information 690 to the default value calculation unit 152. In the unsettable information 690, unavailable parameter values are indicated. The unavailable parameter values are the requested customer environment parameter values for which the abstract representations cannot be described in the simulated environment log 410 by the simulated environment log generation unit 110. Then, the log adjustment unit 151 generates setting information 650 with respect to the requested customer environment parameter values for which the abstract representations can be described in the simulated environment log 410 by the simulated environment log generation unit 110. Then, the log adjustment unit 151 outputs the setting information 650 generated to the simulated environment log generation unit 110.

Meanwhile, when it is possible to describe the abstract representations corresponding to all the requested customer environment parameter values in the simulated environment log 410 by the simulated environment log generation unit 110, the log adjustment unit 151 generates the setting information 650 with respect to all the requested customer environment parameter values. Then, the log adjustment unit 151 outputs the setting information 650 generated, to the simulated environment log generation unit 110.

The log adjustment unit 151 may give an instruction to the simulated environment log generation unit 110 in any format in the setting information 650.

The default value calculation unit 152 acquires the customer environment log statistical information 640. Further, when the unsettable information 690 is acquired from the log adjustment uni 151, the default value calculation unit 152 calculates substitute values (default values) of the unavailable parameter values based on the statistical values indicated in the customer environment log statistical information 640. Then, the default value calculation unit 152 generates the difference default information 660 indicating the substitute values calculated.

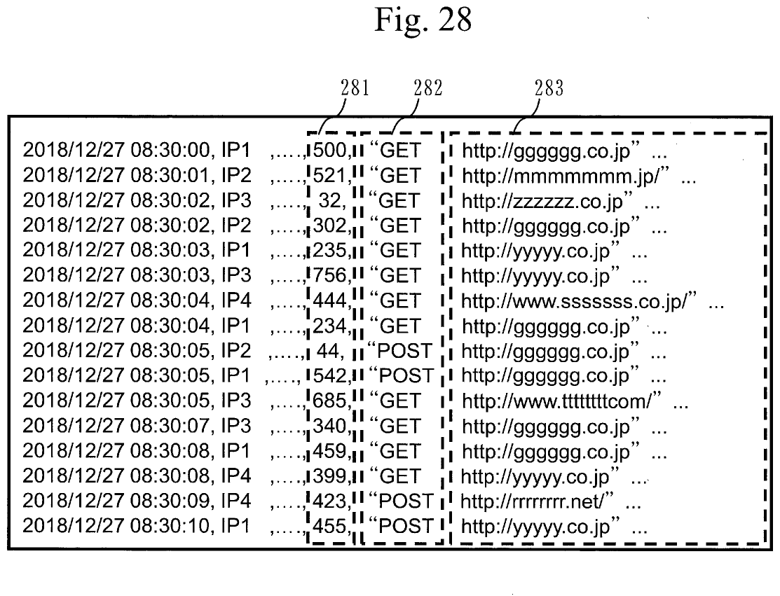

More specifically, when the unavailable parameter values are category data, the default value calculation unit 152 uses appearance frequencies of unique character string included in the unavailable parameter values, and indicated in the customer environment log statistical information 640, and calculates the substitute values of the unavailable parameter values. For example, the default value calculation unit 152 randomly selects the frequency of “mean value+3×standard deviation” from the mean value and the standard deviation of the appearance frequencies. Then, the default value calculation unit 152 sets unique character strings corresponding to the frequencies selected, as the substitute values of the unavailable parameter values. For example, the default value calculation unit 152 calculates appearance frequencies (appearance frequencies of qqqqqq. co. jp, gggg. co. jp, etc.) of the unique character strings of the category data (domain, for example) by the field (range indicated by a symbol 283) in the log exemplified in FIG. 28. Then, the default value calculation unit 152 sorts the category data in the order of the appearance frequency, and randomly selects the category data in the range within X pieces before and after the median. The value of X shall be determined beforehand.

Further, when the unavailable parameter values are numerical value data, the default value calculation unit 152 randomly selects the numerical value of “mean value+3×standard deviation” from, for example, the mean value and the standard deviation of the unavailable parameter values indicated in the customer environment log statistical information 640. For example, the default value calculation unit 152 calculates the mean value and the standard deviation of the numerical value data by the field (range indicated by a symbol 281) in the log exemplified in FIG. 28, and uniformly and randomly generates the substitute values based on the statistical information.

Then, the default value calculation unit 152 sets the numerical values selected as the substitute values of the unavailable parameter values. Further, the default value calculation unit 152 may set fixed values, for example, as the substitute values of the unavailable parameter values.

The default value calculation unit 152 outputs the difference default information 660 to the customer environment log generation unit 130.

The default value calculation unit 152 may give an instruction to the customer environment log generation unit 130 in any format in the difference default information 660.

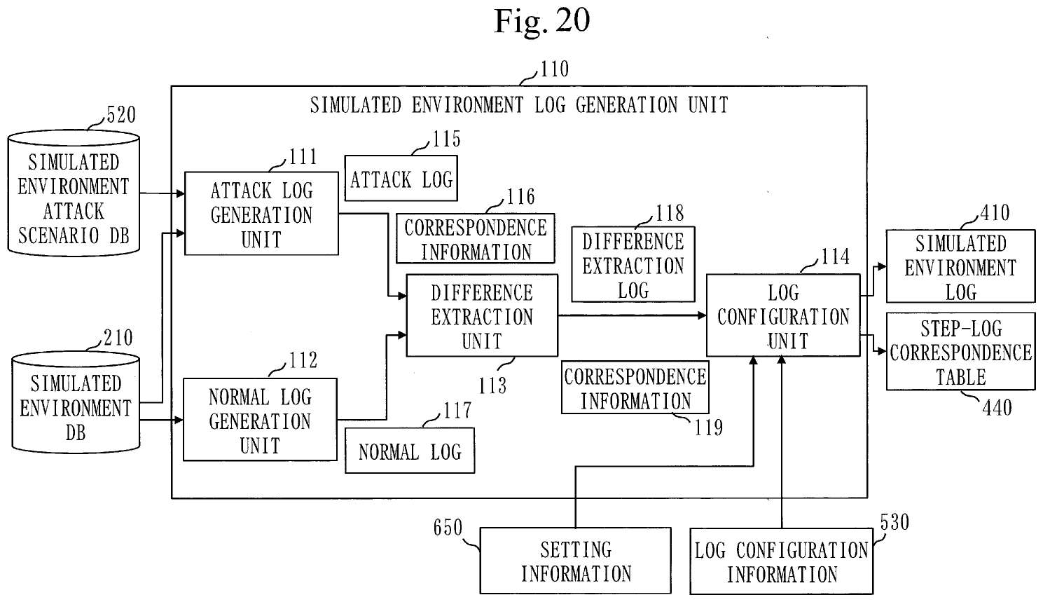

FIG. 20 illustrates the simulated environment log generation unit 110 according to the present embodiment.

In FIG. 20, setting information 650 is added, in comparison to FIG. 5. Elements other than the setting information 650 are the same as those illustrated in FIG. 5.

In the present embodiment, the log configuration unit 114 adds the abstract representation corresponding to the requested customer environment parameter value instructed in the setting information 650, to the difference extraction log 118. As a result, in the simulated environment log 410, the abstract representation corresponding to the requested customer environment parameter value instructed in the setting information 650 is described.

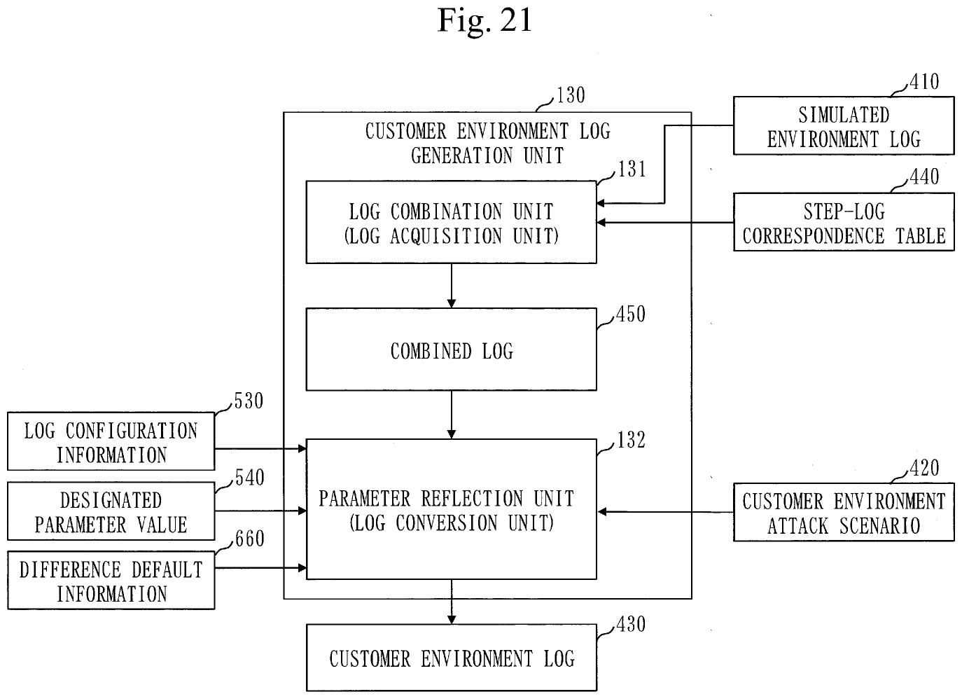

FIG. 21 illustrates the customer environment log generation unit 130 according to the present embodiment.

In FIG. 21, difference default information 660 is added, in comparison to FIG. 8. Elements other than the difference default information 660 are the same as those illustrated in FIG. 8.

In the present embodiment, the parameter reflection unit 132 adds the substitute values of the unavailable parameter values instructed in the difference default information 660, to the combined log 450. As a result, in the customer environment log 430, the substitute values of the unavailable parameter values instructed in the difference default information 660 are described.

### Explanation of Operation

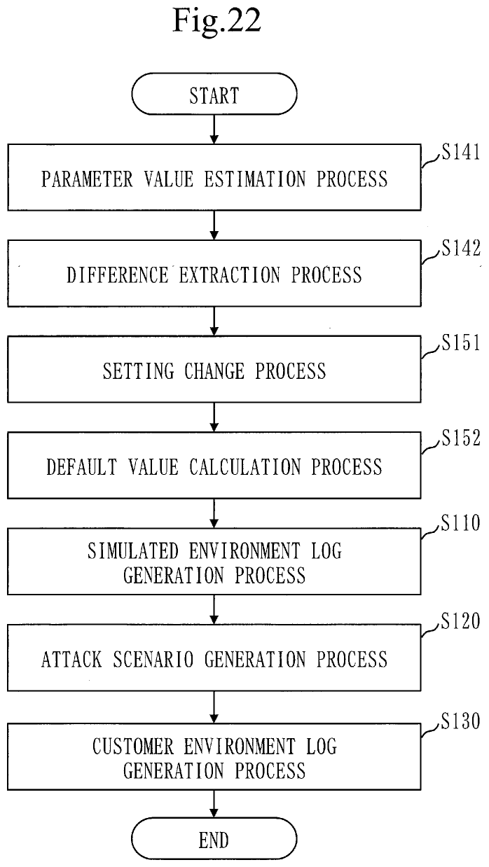

FIG. 22 illustrates an operation example of the log processing device 100 according to the present embodiment.

In FIG. 22, Step S141 through Step S152 are performed before Step S110 through Step S130.

In Step S141, the parameter value estimation unit 141 estimates a simulated environment parameter value and a customer environment parameter value.

More specifically, the parameter value estimation unit 141 analyzes the simulated environment sample log 610, and estimates the simulated environment parameter values included in the simulated environment log 410. Then, the parameter value estimation unit 141 outputs the simulated environment parameter values acquired by estimation, as the estimated simulated-environment parameter values 670, to the difference extraction unit 142.

Further, the parameter value estimation unit 141 analyzes the customer environment sample log 620, and estimates the customer environment parameter values included in the customer environment log 430. Then, the parameter value estimation unit 141 outputs the customer environment parameter values acquired by estimation, as the estimated customer-environment parameter values 680, to the difference extraction unit 142.

Furthermore, the parameter value estimation unit 141 calculates statistical values of the estimated customer-environment parameter values 680, and generates the customer environment log statistical information 640 indicating the statistical values of the estimated customer-environment parameter values 680 calculated. Then, the parameter value estimation unit 141 outputs the customer environment log statistical information 640 generated, to the setting change unit 150.

Next, in Step S142, the difference extraction unit 142 extracts differences between the simulated environment parameter values and the customer environment parameter values.

More specifically, the difference extraction unit 142 compares the estimated simulated-environment parameter values 670 with the estimated customer-environment parameter values 680. Then, when estimated customer-environment parameter values 680 different from the estimated simulated-environment parameter values 670 (for example, a referrer, a status code or the like) exists, the parameter decision unit 140 extracts the referenced estimated customer-environment parameter values 680 as the requested customer environment parameter values. Then, the parameter decision unit 140 outputs the difference parameter value information 630 indicating the requested customer environment parameter values extracted, to the setting change unit 150.

In Step S151, the log adjustment unit 151 changes setting of the simulated environment log generation unit 110.

More specifically, the log adjustment unit 151 decides whether the abstract representations corresponding to all the requested customer environment parameter values indicated in the difference parameter value information 630 can be described in the simulated environment log 410 by the simulated environment log generation unit 110.

Then, when an abstract representation corresponding to any of the requested customer environment parameter values cannot be described in the simulated environment log 410 by the simulated environment log generation unit 151, the log adjustment unit 151 outputs unsettable information 690, to the default value calculation unit 152. Then, the log adjustment unit 151 generates the setting information 650 with respect to the requested customer environment parameter values for which the abstract representations can be described in the simulated environment log 410 by the simulated environment log generation unit 110. Then, the log adjustment unit 151 outputs the setting information 650 generated, to the simulated environment log generation unit 110.

In Step S152, the default value calculation unit 152 calculates the substitute values (default values) of the unavailable parameter values.

More specifically, the default value calculation unit 152 acquires the customer environment log statistical information 640. Further, the default value calculation unit 152 acquires the unsettable information 690 from the log adjustment unit 151. Then, the default value calculation unit 152 calculates the substitute values of the unavailable parameter values based on the statistical values indicated in the customer environment log statistical information 640. Then, the default value calculation unit 152 generates the difference default information 660 indicating the substitute values calculated.

Then, the default value calculation unit 152 outputs the difference default information 660, to the customer environment log generation unit 130.

In Step S110, the simulated environment log generation unit 110 generates the simulated environment log 410.

When the setting information 650 is output from the log adjustment unit 151, the simulated environment log generation unit 110 generates the simulated environment log 410 so that the abstract representations corresponding to the requested customer environment parameter values indicated in the setting information 650 are included.

The other operations of the simulated environment log generation unit 110 are as indicated in First Embodiment.

Step S120 is as indicated in First Embodiment.

In Step S130, the customer environment log generation unit 130 generates the customer environment log 430.

When the difference default information 660 is output from the default value calculation unit 152, the customer environment log generation unit 130 generates the customer environment log 430 so that the substitute values of the unavailable parameter values indicated in the difference default information 660 are included.

The other operations of the customer environment log generation unit 130 are as indicated in First Embodiment.

Description will be made on Step S141 in detail.

Hereinafter, description will be made on an example wherein the parameter decision unit 140 estimates the simulated environment parameter value in the simulated environment sample log 610. However, by replacing the simulated environment sample log 610 with the customer environment sample log 620, and the simulated environment parameter value with the customer environment parameter value in the description below, the parameter decision unit 140 is capable of estimating the customer environment parameter value in the customer environment sample log 620 in the similar procedure.

Hereinafter, description will be made on an estimation method of the customer environment parameter value.

The parameter decision unit 140 extracts a feature of each record in the simulated environment sample log 610. In a case of records wherein category data of domains or the like is described, the parameter decision unit 140 converts the records into a suitable representation, such as BoW (Bag of Words), etc., and extracts the feature.

More specifically, the parameter decision unit 140 performs search and estimation in the following manner.
1. One record (line) is constituted of a plurality of fields separated by specific separators (for example, spaces or commas).
2. The parameter decision unit 140 extracts the fields by using separators as cues.
3. The parameter decision unit 140 extracts a same column (field) from all records in a log. For example, in the log exemplified in FIG. 28, each of the range of a sign 281, the range of a sign 282 and the range of the sign 283 is extracted as the same column.
4. When the same column is constituted only of numerals, the parameter decision unit 140 handles data of the referenced column as numerical value data. In the other cases, the parameter decision unit 140 handles data of the referenced column as category data.
5. In a case of category data, the parameter decision unit 140 extracts frequencies of words, and converts the character strings into numerical value representations in such a method as BoW, etc. For example, the parameter decision unit 140 converts “http://yyyyyy. co. jp” into (11110000) with {http:1, yyyyyy:1, co: 1, jp:1}.
6. Next, the parameter decision unit 140 merges the numerical value representations (in the case of category data) acquired by conversion and the numerical value data by the same column (range of the sign 283) and inputs it in machine learning, and estimates the type of the column (field).

A classifier to classify the types of columns shall be learned beforehand using data of each column in logs wherein fields (parameter values) have already been known.

In a case of records wherein numerical value data of reception size or the like is described, the parameter decision unit 140 appropriately performs standardization of data, and extracts the feature.

Next, the parameter decision unit 140 estimates what kind of parameter value the feature extracted is, using a classifier generated by machine learning. This classifier is a classifier obtained beforehand by supervised learning using parameter values included in various logs. The classification algorithm used in supervised learning is, for example, random forest, a neural network or the like.

### Description of Effect of Embodiment

As described above, according to the present embodiment, it is possible to add a parameter value (requested customer environment parameter value) which is not included in the simulated environment log 410, but is requested to be included in the customer environment log 430, to the customer environment log 430.

Therefore, according to the present embodiment, it is possible to acquire a log of the customer environment more similar to the actual state, and to construct an attack detection system more effective than that in First Embodiment.

In the above, description has been made on the example where the parameter decision unit 140 decides whether the abstract representation corresponding to the requested customer environment parameter value is described in the simulated environment log 410.

However, as described in First Embodiment, in the case where not the abstract representations, but the simulated environment parameter values are described in the simulated environment log 410, the parameter decision unit 140 decides whether the simulated environment parameter value corresponding to the requested customer environment parameter value is described in the simulated environment log 410.

In this case, the simulated environment log generation unit 110 adds to the simulated environment log 410, not the abstract representation, but the simulated environment parameter value corresponding to the requested customer environment parameter value.

Further, in the above, description has been made on the example wherein the customer environment log generation unit 130 adds the substitute values of the unavailable parameter values to the combined log 450.

However, the customer environment log generation unit 130 may add to the combined log 450, not the substitute values, but the unavailable parameter values.

### Third Embodiment

In the present embodiment, description will be made mainly on differences from First Embodiment.

The items not described below are the same as those in First Embodiment.

### ***Description of Configuration***

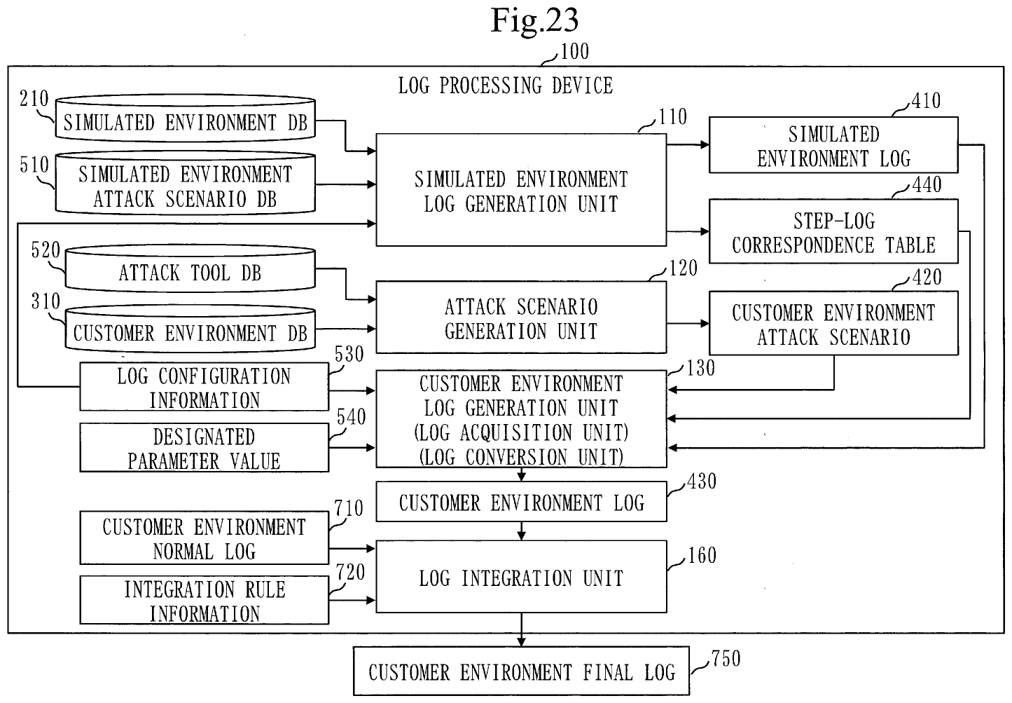

FIG. 23 illustrates an example of a functional configuration of the log processing device 100 according to the present embodiment.

In FIG. 23, a log integration unit 160, a customer environment normal log 710, integration rule information 720 and a customer environment final log 750 are added in comparison to FIG. 3.

Hereinafter, description will be made mainly on the log integration unit 160, the customer environment normal log 710, the integration rule information 720 and the customer environment integrated log 730.

The example of the hardware configuration of the log processing device 100 according to the present embodiment is as illustrated in FIG. 4.

The log integration unit 160 is realized by programs as with the customer environment log generation unit 130, etc. The processor 901 executes the programs to realize the function of the log integration unit 160, and performs the operation of the log integration unit to be described below.

The log integration unit 160 refers to the integration rule information 720, and integrates the customer environment log 430 and the customer environment normal log 710.

The customer environment normal log 710 indicates a behavior that is estimated to occur in the customer environment 300 when the customer environment 300 is not subject to attack. The customer environment normal log 710 corresponds to an actual environment normal log.

The integration rule information 720 indicates rules for the log integration unit 160 to integrate the customer environment log 430 and the customer environment normal log 710.

The integration rule information 720 indicates, for example, a rule to convert the format of the customer environment log 430 in accordance with the format of the customer environment normal log 710.

Further, the log integration unit 160 corrects records in the log after integration based on a destruction event. Hereinafter, the log after integration by the log integration unit 160 is referred to as a customer environment integrated log 730. The customer environment integrated log 730 corresponds to an actual environment integrated log.

As described above, the customer environment 300 includes a plurality of system components such as a PC, a proxy server device, an AD server device, a file server device, an internal network, a file, a user and the like. Hereinafter, the system components are referred to as objects.

The customer environment integrated log 730 includes the customer environment log 430 being a log when the customer environment 300 is attacked. Therefore, in the customer environment integrated log 730, the destruction event being an event wherein any of the objects is destroyed is described. Meanwhile, the customer environment integrated log 730 also includes a customer environment normal log 710 being a log when the customer environment 300 has not been attacked. Therefore, in the description of the customer environment integrated log 730 after the destruction event has occurred, a part of the customer environment normal log 710 has a description based on a premise that the object being a target of destruction event (called a destruction object hereinafter) has not been destroyed. That is, the customer environment integrated log 730 includes description that the destruction object is not destroyed even after the destruction event has occurred and the destruction object has been destroyed.

The log integration unit 160 changes the description of the customer environment integrated log 730 after the destruction event has occurred into description based on a premise that the destruction object has been destroyed.

The destruction object corresponds to a destruction system component.

The log integration unit 160 outputs the customer environment integrated log 730 after changing the description after occurrence of the destruction event, as the customer environment final log 750.

The customer environment final log 750 is, for example, used as learning data in machine learning at the time of constructing an attack detection system.

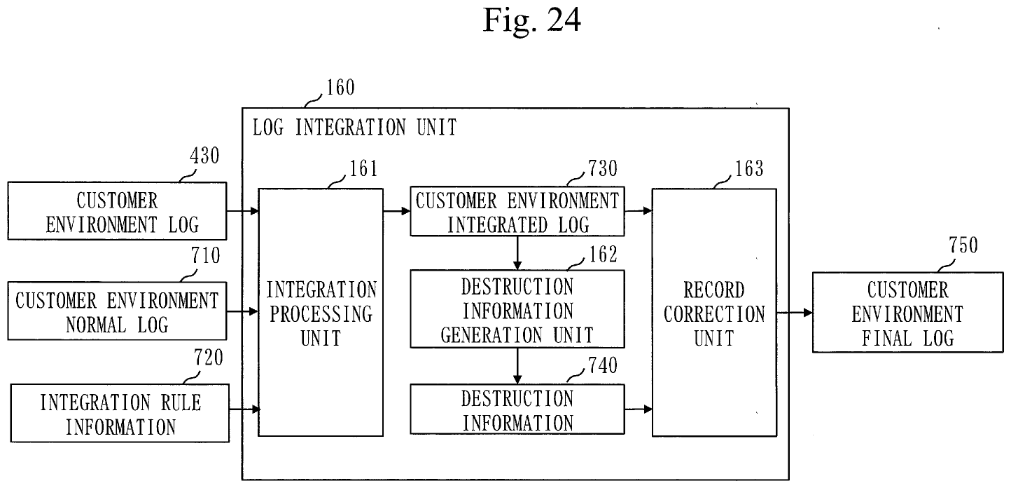

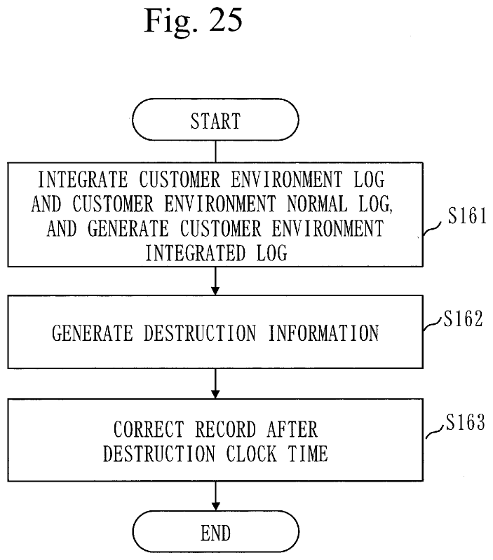

FIG. 24 illustrates an example of an internal configuration of the log integration unit 160.

An integration processing unit 161 integrates the customer environment log 430 and the customer environment normal log 710 in accordance with the integration rule information 720.

The integration processing unit 161 integrates the customer environment normal log 710 and the customer environment log 430 after converting the format of the customer environment log 430 in accordance with the format of the customer environment normal log 710, for example.

The integration processing unit 161 integrates the customer environment log 430 and the customer environment normal log 710 along time series.

Then, the integration processing unit 161 outputs the customer environment integrated log 730 acquired by integration, to a destruction information generation unit 162 and a record correction unit 163.

The destruction information generation unit 162 analyzes the customer environment integrated log 730, and extracts the destruction event from the customer environment integrated log 730. Then, the destruction information generation unit 162 generates destruction information 740 indicating details of the destruction event extracted. Then, the destruction information generation unit 162 outputs the destruction information 740 generated, to the record correction unit 163.

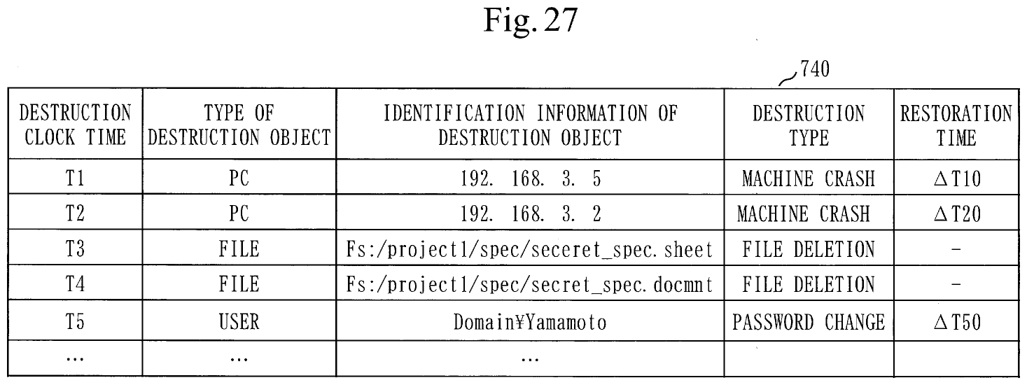

FIG. 27 illustrates an example of the destruction information 740. The detail of FIG. 27 will be described later.

The record correction unit 163 corrects a record in the customer environment integrated log 730 after the destruction event has occurred into a record based on a premise that the destruction object has been destroyed.

Then, the record correction unit 163 outputs the customer environment integrated log 730 after record correction as the customer environment final log 750.

### Description of Operation

FIG. 24 illustrates an operation example of the log processing device 100 according to the present embodiment.

Specifically, FIG. 24 illustrates an operation example of the log integration unit 160.

First, in Step S161, the integration processing unit 161 integrates the customer environment log 430 and the customer environment normal log 710 in accordance with the integration rule information 720. Then, the integration processing unit 161 outputs the customer environment integrated log 730 to the destruction information generation unit 162 and the record correction unit 163.

Next, in Step S162, the destruction information generation unit 162 generates the destruction information 740.

First, the destruction information generation unit 162 analyzes the customer environment integrated log 730, and extracts the destruction event from the customer environment integrated log 730.

Specifically, the destruction information generation unit 162 selects a customer environment integrated log 730 corresponding to an attack step wherein destruction is performed among a plurality of customer environment integrated logs 730, and analyzes the customer environment integrated log 730 selected. The attack step wherein the destruction is performed is, for example, an attack step of machine crash, file deletion, password change, file encryption or the like.

Then, the destruction information generation unit 162 extracts a destruction act to destroy any of the objects in the customer environment 300 in the customer environment integrated log 730 selected, as the destruction event.

The destruction act to be extracted as the destruction event shall be defined beforehand by, for example, a manager of the log processing device 100.

Then, the destruction information generation unit 162 generates, for example, the destruction information 740 illustrated in FIG. 27.

In FIG. 27, “destruction clock time” indicates a clock time when the destruction event occurs. Further, “type of destruction object” indicates the type of destruction object. Further, “identification information of destruction object” indicates identification information capable of uniquely identifying the destruction object. Furthermore, “destruction type” indicates the type of the destruction behavior. Additionally, “restoration time” indicates a time required to restore the destruction object.

In a case where “destruction type” is file deletion, “identification information of destruction object” indicates a file path of the file that has been deleted. In a case where “destruction type” is machine crash, “identification information of destruction object” indicates an IP address of the machine that has crashed. Further, in a case where “destruction type” is password change, “identification information of destruction object” indicates an ID of a user whose password has been changed.

Lastly, in Step S163, the record correction unit 163 corrects the record after a destruction clock time in the customer environment integrated log 730 for each destruction time indicated in the destruction information 740.

Details of Step S163 will be described later.

According to the above, the record correction unit 163 corrects the record in the customer environment integrated log 730 after the destruction event has occurred into a record based on a premise that the destruction object has been destroyed. Then, the record correction unit 163 outputs the customer environment integrated log 730 after record correction, as the customer environment final log 750.

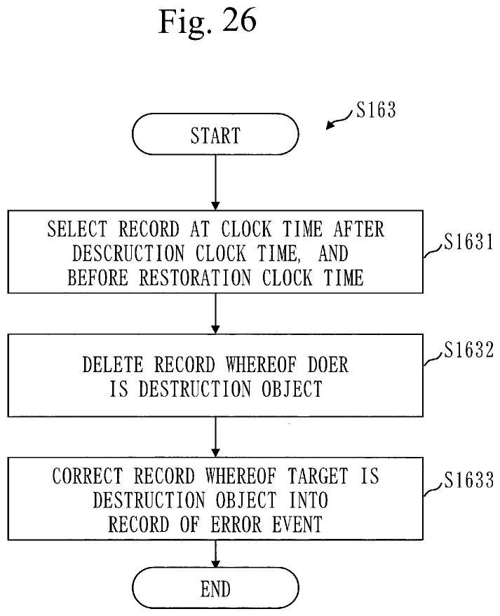

Next, description will be made on Step S163 in detail, with reference to FIG. 26.

The record correction unit 163 performs the process in FIG. 26 for each record in the destruction information 240 in FIG. 27.

First, in Step S1631, the record correction unit 163 selects records at clock times after the destruction clock time in the customer environment integrated log 730, which are the records at clock times before a restoration clock time.

The restoration clock time is a clock time obtained by adding the time indicated in “restoration time” to the clock time indicated in “destruction clock time” in the destruction information 740.

In a case where “restoration time” is blank, the record correction unit 163 selects all records at clock times after the destruction clock time.

Next, in Step S1632, the record correction unit 163 deletes a record wherein the doer is the destruction object, from the records selected in Step S1631.

That is, the record correction unit 163 deletes the record wherein the destruction object specified in “identification information of destruction object” of the destruction information 740 is the doer of behavior, from the customer environment integrated log 730. Since the behavior whereof the doer is the destruction object does not occur from the destruction clock time to the restoration clock time, the record correction unit 163 deletes the relevant record.

Next, in Step S1633, the record correction unit 163 corrects a record wherein a target is the destruction object among the records selected in Step S1631 into a record of an error event.

That is, the record correction unit 163 corrects the record wherein the destruction object specified by “identification information of destruction object” in the destruction information 740 among the records selected in Step S1631 is the target of behavior, into the record of the error event. Since the behavior whereof the target is the destruction object is terminated with an error between the destruction clock time and the restoration clock time, the record correction unit 163 corrects the relevant record into the record of the error event.

The record correction unit 163 specifically corrects the relevant record into a record indicating that access to the destruction object, an authentication process for the destruction object and the like have been terminated with an error.

For example, with respect to the first line in FIG. 27, the record correction unit 163 deletes a record wherein a destruction object (PC) specified by “identification information of destruction object: 192. 168. 3. 5” is the doer of behavior, from records at clock times after “destruction clock time: T1” and before “restoration clock time: T1+ΔT10”.

For example, the record correction unit 163 deletes a record indicating communication started by the relevant PC.

Further, for example, in the third line in FIG. 27, “restoration clock time” is blank. Therefore, the record correction unit 163 changes all records wherein the destruction object (file) specified by “identification information of destruction object: Fs:/project1/spec/secret_spec. sheet” is the target of behavior, which are records at clock times after “destruction clock time: T3”, into records of the error events.

For example, the record correction unit 163 changes records indicating that access to the relevant file has been successful, into records indicating that an access error has occurred.

### Description of Effect of Embodiment

As described above, according to the present embodiment, it is possible to correct description of the customer environment integrated log 730 after a destruction event has occurred.

Therefore, according to the present embodiment, it is possible to obtain a log of the customer environment more similar to the actual state, and to construct an attack detection system more effective than that in First Embodiment.

### Fourth Embodiment

In the present embodiment, description will be made mainly on differences from First Embodiment and Second Embodiment.

The items not described below are similar to those in First Embodiment and Second Embodiment.

### ***Description of Configuration***

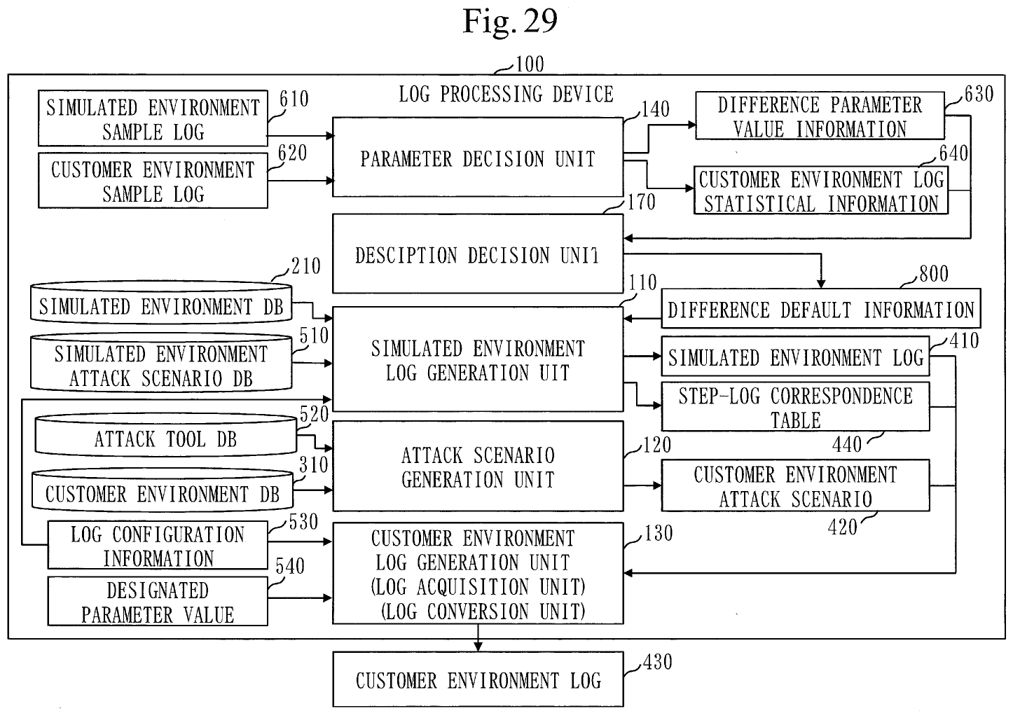

FIG. 29 illustrates an example of a functional configuration of the log processing device 100 according to the present embodiment.

In FIG. 29, a parameter decision unit 140, a description instruction unit 170, a simulated environment sample log 610, a customer environment sample log 620, difference parameter value information 630, customer environment log statistical information 640 and difference default information 800 are added, in comparison to FIG. 3.

In FIG. 29, the parameter decision unit 140, the simulated environment sample log 610, the customer environment sample log 620, the difference parameter value information 630 and the customer environment log statistical information 640 are similar to those described in Second Embodiment.

In the present embodiment, the parameter decision unit 140 outputs the difference parameter value information 630 and the customer environment log statistical information 640, to the description instruction unit 170.

Further, in the present embodiment, the simulated environment log generation unit 110 describes the substitute value of the requested customer environment parameter value in the simulated environment log 410 in accordance with the difference default information 800.

The example of the hardware configuration of the log processing device 100 according to the present embodiment is as illustrated in FIG. 4.

The description instruction unit 170 is realized by a program as with the customer environment log generation unit 130 and the like. The processor 901 executes the program to realize the function of the description instruction unit 170, and performs an operation of the description instruction unit 170 as described below.

When it is decided that an abstract representation corresponding to the requested customer environment parameter value is not described in the simulated environment log 410 by the parameter decision unit 140, the description instruction unit 170 instructs the simulated environment log generation unit 110 being a generation source of the simulated environment log 410 to describe the substitute value of the requested customer environment parameter value in the simulated environment log 410.

The description instruction unit 170 instructs the simulated environment log generation unit 110 to describe the substitute value of the requested customer environment parameter value in the simulated environment log 410 by outputting the difference default information 800 to the simulated environment log generation unit 110.

The description instruction unit 170 generates the difference default information 800 from the difference parameter value information 630 and the customer environment log statistical information 640.

The difference default information 800 is a command to instruct the customer environment log generation unit 130 to describe the substitute value of the requested customer environment parameter value in the simulated environment log 410. The difference default information 800 indicates the substitute value calculated based on a statistical value indicated in the customer environment log statistical information 640.

### Description of Operation

The description instruction unit 170 acquires the difference parameter value information 630 and the customer environment log statistical information 640 from the parameter decision unit 140. As described in Second Embodiment, in the difference parameter value information 630, parameter values not included in the simulated environment sample log 610 but included in the customer environment sample log 620 are indicated as the requested customer environment parameter values. Further, in the customer environment log statistical information 640, as described in Second Embodiment, statistical values of the parameter values included in the customer environment sample log 620 is indicated.

The description instruction unit 170 calculates the substitute values (default values) of the requested customer environment parameter values based on the statistical values indicated in the customer environment log statistical information 640. Then, the description instruction unit 170 generates the difference default information 800 indicating the substitute values calculated.

More specifically, when the requested customer environment parameter values are category data, the description instruction unit 170 calculates the substitute values, using appearance frequencies of unique character strings included in the requested customer environment parameter values, which are indicated in the customer environment log statistical information 640. For example, the description instruction unit 170 randomly selects the frequency of “mean value±3×standard deviation” from the mean value and the standard deviation of the appearance frequencies.

Then, the description instruction unit 170 sets unique character strings corresponding to the frequency selected, as the substitute values.

More specifically, the description instruction unit 170 sets the substitute values of the requested customer environment parameter values in a procedure similar to the setting procedure of the substitute values in the case where the unavailable parameter values are category data, as described with reference to FIG. 28 in Second Embodiment.

Further, when the requested customer environment parameter values are numerical value data, the description instruction unit 170 randomly selects numerical values of “mean value±3×standard deviation” from, for example, the mean value and the standard deviation of the requested customer environment parameter values, indicated in the customer environment log statistical information 640.

Then, the description instruction unit 170 sets the numerical values selected as the substitute values of the requested customer environment parameter values. Further, the description instruction unit 170 may set fixed values, for example, as the substitute values of the requested customer environment parameter values.

More specifically, the description instruction unit 170 sets the substitute values of the requested customer environment parameter values in a procedure similar to the setting procedure of the substitute values in the case where the unavailable parameter values are numerical value data, as described with reference to FIG. 28 in Second Embodiment.

The description instruction unit 170 may give an instruction to the simulated environment log generation unit 110 in any format in the difference default information 800.

The simulated environment log generation unit 110 according to the present embodiment adds the substitute values of the requested customer environment parameter values instructed in the difference default information 800 to the difference extraction log 118. As a result, the substitute values of the requested customer environment parameter values instructed in the difference default information 800 are added to the simulated environment log 410.

### Description of Effect of Embodiment

As described above, according to the present embodiment, it is possible to add, to the simulated environment log 410, the substitute values of the parameter values (requested customer environment parameter values) requested to be included in the customer environment log 430, which are not included in the simulated environment log 410.

Therefore, according to the present embodiment, it is possible to obtain a log of the customer environment more similar to the actual state, and to construct an attack detection system more effective than that in First Embodiment.

In the above, First through Fourth Embodiments have been described; however, two or more of these embodiments may be combined and performed.

Otherwise, one of these embodiments may be partially performed.

Meanwhile, two or more of these embodiments may be partially combined and performed.

Further, the configurations and procedures described in these embodiments may be changed as needed.

### ***Supplementary Description of Hardware Configuration***

Lastly, supplementary description will be made on the hardware configuration of the log processing device 100.

The processor 901 illustrated in FIG. 4 is an IC (Integrated Circuit) to perform processing.

The processor 901 is a CPU (Central Processing Unit), a DSP (Digital Signal Processor) or the like.

The main storage device 902 illustrated in FIG. 4 is a RAM (Random Access Memory).

The auxiliary storage device 903 illustrated in FIG. 4 is an ROM (Read Only Memory), a flash memory, an HDD (Hard Disk Drive) or the like.

The communication device 904 illustrated in FIG. 4 is an electronic circuit to perform communication processing of data.

The communication device 904 is a communication chip or an NIC (Network Interface Card), for example.

Further, the auxiliary storage device 903 also stores an OS (Operating System).

In addition, at least a part of the OS is executed by the processor 901.

The processor 901 executes programs to realize the functions of the simulated environment log generation unit 110, the attack scenario generation unit 120, the customer environment log generation unit 130, the parameter decision unit 140, the setting change unit 150, the log integration unit 160 and the description instruction unit 170 while executing at least a part of the OS.

By executing the OS by the processor 901, task management, memory management, file management, communication control and the like are performed.

Further, at least any of information, data, signal values and variable values indicating results of processing by the simulated environment log generation unit 110, the attack scenario generation unit 120, the customer environment log generation unit 130, the parameter decision unit 140, the setting change unit 150, the log integration unit 160 and the description instruction unit 170 is stored in at least any of the main storage device 902, the auxiliary storage device 903, and a register and cache memory inside the processor 901.

Further, the programs to realize the functions of the simulated environment log generation unit 110, the attack scenario generation unit 120, the customer environment log generation unit 130, the parameter decision unit 140, the setting change unit 150, the log integration unit 160 and the description instruction unit 170 may be stored in a portable recording medium such as a magnetic disk, a flexible disk, an optical disk, a compact disk, a Blue-ray (registered trademark) disk, a DVD (digital versatile disk) or the like. Additionally, it may be possible to distribute the portable recording medium wherein the programs to realize the functions of the simulated environment log generation unit 110, the attack scenario generation unit 120, the customer environment log generation unit 130, the parameter decision unit 140, the setting change unit 150, the log integration unit 160 and the description instruction unit 170 are stored.

Further, “unit” of the simulated environment log generation unit 110, the attack scenario generation unit 120, the customer environment log generation unit 130, the parameter decision unit 140, the setting change unit 150, the log integration unit 160 and the description instruction unit 170 may be replaced with “circuit”, “step”, “procedure”, “process” or “circuitry”.

In addition, the log processing device 100 may be realized by a processing circuit. The processing circuit is, for example, a logic IC (Integrated Circuit), a GA (Gate Array), an ASIC (Application Specific Integrated Circuit) or an FPGA (Field-Programmable Gate Array).

In this case, the simulated environment log generation unit 110, the attack scenario generation unit 120, the customer environment log generation unit 130, the parameter decision unit 140, the setting change unit 150, the log integration unit 160 and the description instruction unit 170 are each realized as a part of the processing circuit.

In the present specification, a superordinate concept of the processor and the processing circuit is called “processing circuitry”.

That is, each of the processor and the processing circuit is a concrete example of “processing circuitry”.

### REFERENCE SIGNS LIST

100: log processing device; 110: simulated environment log generation unit; 111: attack log generation unit; 112: normal log generation unit; 113: difference extraction unit; 114: log configuration unit; 115: attack log; 116: correspondence information; 117: normal log; 118: difference extraction log; 119: correspondence information; 120: attack scenario generation unit; 130: customer environment log generation unit; 131: log combination unit; 132: parameter reflection unit; 140: parameter decision unit; 141: parameter value estimation unit; 142: difference extraction unit; 150: setting change unit; 151: log adjustment unit; 152: default value calculation unit; 160: log integration unit; 161: integration processing unit; 162: destruction information generation unit; 163: record correction unit; 170: description instruction unit; 200: simulated environment; 210: simulated environment DB; 300: customer environment; 310: customer environment DB; 410: simulated environment log; 420: customer environment attack scenario; 430: customer environment log; 440: step-log correspondence table; 450: combined log; 510: simulated environment attack scenario DB; 520: attack tool DB; 530: log configuration information; 540: designated parameter value; 610: simulated environment sample log; 620: customer environment sample log; 630: difference parameter value information; 640: customer environment log statistical information; 650: setting information; 660: difference default information; 670: estimated simulated-environment parameter value; 680: estimated customer-environment parameter value; 690: unsettable information; 710: customer environment normal log; 720: integration rule information; 730: customer environment integrated log; 740: destruction information; 750: customer environment final log; 800: difference default information; 901: processor; 902: main storage device; 903: auxiliary storage device; 904: communication device

1. A log processing device comprising:
processing circuitry
to acquire a simulated environment log being a log that indicates a behavior estimated to occur in a simulated environment when an attack is made on the simulated environment being a system environment which simulates an actual environment being an actual system environment and which has a difference from the actual environment, and
to convert the simulated environment log into an actual environment log being a log that indicates a behavior estimated to occur in the actual environment when an attack corresponding to the attack against the simulated environment is made on the actual environment, by reflecting the difference between the simulated environment and the actual environment.

2. The log processing device as defined in claim 1, wherein the processing circuitry converts the simulated environment log into the actual environment log, by reflecting a difference between a simulated environment parameter value being a parameter value used in the simulated environment and an actual environment parameter value being a parameter used in the actual environment.

3. The log processing device as defined in claim 2, wherein the processing circuitry acquires the simulated environment log wherein any of the simulated environment parameter value and an abstract representation of the simulated environment parameter value is indicated, and
the processing circuitry replaces any of the simulated environment parameter value and the abstract representation indicated in the simulated environment log with the actual environment parameter value, and converts the simulated environment log into the actual environment log.

4. The log processing device as defined in claim 1, wherein the processing circuitry acquires a plurality of logs generated for a plurality of attack steps included in the attack against the simulated environment, as a plurality of simulated environment logs, and
the processing circuitry converts the plurality of simulated environment logs into a plurality of actual environment logs.

5. The log processing device as defined in claim 4, wherein the processing circuitry acquires the plurality of simulated environment logs each indicating any of a simulated environment parameter value being a parameter value used in the simulated environment and an abstract representation of the simulated environment parameter value, and
the processing circuitry replaces any of the simulated environment parameter value and the abstract representation indicated in each of the plurality of simulated environment logs with an actual environment parameter value being a parameter value used in the actual environment, and converts the plurality of simulated environment logs into the plurality of actual environment logs.

6. The log processing device as defined in claim 1, wherein when a normal behavior being a behavior estimated to occur in the simulated environment when an attack is not made on the simulated environment is included in a behavior-under attack being a behavior estimated to occur in the simulated environment when the attack is made on the simulated environment, the processing circuitry acquires a log indicating a behavior after the normal behavior has been excluded from the behavior-under attack, as the simulated environment log.

7. The log processing device as defined in claim 1, wherein the processing circuitry excludes, when a normal behavior being a behavior estimated to occur in the simulated environment when an attack is not made on the simulated environment is included in a behavior-under attack being a behavior estimated to occur in the simulated environment when the attack is made on the simulated environment, the normal behavior from the behavior-under attack, and generates a log indicating a behavior after the normal behavior has been excluded from the behavior-under attack, as the simulated environment log, and
the processing circuitry acquires the simulated environment log generated.

8. The log processing device as defined in claim 2, wherein when a parameter value other than the actual environment parameter value is designated as a designated parameter value, the processing circuitry reflects the designated parameter value to the simulated environment log.

9. The log processing device as defined in claim 3, wherein the processing circuitry decides whether any of the simulated environment parameter value and the abstract representation corresponding to a requested actual environment parameter value is described in the simulated environment log, the requested actual environment parameter being the actual environment parameter value requested to be described in the actual environment log, and
the processing circuitry changes, when it is decided that any of the simulated environment parameter value and the abstract representation corresponding to the requested actual environment parameter value is not described in the simulated environment log, a setting of the simulated environment log so that any of the simulated environment parameter value and the abstract representation corresponding to the requested actual environment parameter value is described in the simulated environment log.

10. The log processing device as defined in claim 9, wherein when changing the setting of the simulated environment log does not cause any of the simulated environment parameter value and the abstract representation corresponding to the requested actual environment parameter value to be described in the simulated environment log, the processing circuitry adds any of the requested actual environment parameter value and a substitute value of the requested actual environment parameter value to the simulated environment log.

11. The log processing device as defined in claim 1, wherein the processing circuitry integrates the actual environment log and an actual environment normal log indicating a behavior estimated to occur in the actual environment when the attack is not made on the actual environment.

12. The log processing device as defined in claim 11, wherein the actual environment includes a plurality of system components, and
when a destruction event being an event wherein any system component among the plurality of system components is destroyed is described in an actual environment integrated log acquired by integrating the actual environment log and the actual environment normal log, and when a description in the actual environment integrated log after occurrence of the destruction event is a description based on a premise that a destruction system component being a system component which is a target of the destruction event has not been destroyed, the processing circuitry changes the description in the actual environment integrated log after occurrence of the destruction event into a description based on a premise that the destruction system component has been destroyed.

13. The log processing device as defined in claim 3, wherein the processing circuitry decides whether any of the simulated environment parameter value and the abstract representation corresponding to a requested actual environment parameter value is described in the simulated environment log, the requested actual environment parameter value being the actual environment parameter value requested to be described in the actual environment log, and
the processing circuitry instructs, when it is decided that any of the simulated environment parameter value and the abstract representation corresponding to the requested actual environment parameter value is not described in the simulated environment log, a generation source of the simulated environment log to describe a substitute value of the requested actual environment parameter value in the simulated environment log.

14. A log processing method comprising:
acquiring a simulated environment log being a log that indicates a behavior estimated to occur in a simulated environment when an attack is made on the simulated environment being a system environment which simulates an actual environment being an actual system environment and which has a difference from the actual environment, and
converting the simulated environment log into an actual environment log being a log that indicates a behavior estimated to occur in the actual environment when an attack corresponding to the attack against the simulated environment is made on the actual environment, by reflecting the difference between the simulated environment and the actual environment.

15. A non-transitory computer readable medium storing a log processing program to make a computer perform:
a log acquisition process to acquire a simulated environment log being a log that indicates a behavior estimated to occur in a simulated environment when an attack is made on the simulated environment being a system environment which simulates an actual environment being an actual system environment and which has a difference from the actual environment, and
a log conversion process to convert the simulated environment log into an actual environment log being a log that indicates a behavior estimated to occur in the actual environment when an attack corresponding to the attack against the simulated environment is made on the actual environment, by reflecting the difference between the simulated environment and the actual environment.
